(19) United States
(12) Patent Application Publication
(10) Pub. No.: US 2026/0296028 A1
(43) Pub. Date: Oct. 1, 2026

(54) LIQUID EJECTION APPARATUS

(71) Applicant: CANON KABUSHIKI KAISHA, Tokyo (JP)

(72) Inventors: KAITO YAMAZAKI, Tokyo (JP); RYOSUKE ARAKI, Kanagawa (JP); SHU KURIHARA, Tokyo (JP); TOMOHIRO SUZUKI, Tokyo (JP); ITARU WADA, Kanagawa (JP); YOSHIYUKI INAMOTO, Tokyo (JP)

(21) Appl. No.: 19/572,358

(22) Filed: Mar. 19, 2026

(30) Foreign Application Priority Data
Mar. 27, 2025 (JP) 2025-054629
Mar. 28, 2025 (JP) 2025-055931

(51) Int. Cl. B41J 2/165; B41J 2/17

(52) U.S. Cl. CPC B41J 2/16523; B41J 2/1721

(57) ABSTRACT

A liquid ejection apparatus has a tank for storing liquid, a liquid flow channel for discharging the liquid into the tank, and a connecting unit capable of connecting the tank and the liquid flow channel. The tank has a waste liquid port for discarding the liquid stored and a cap for closing the waste liquid port. The cap is provided with a liquid discharging port for taking the discharged liquid into the tank and an atmosphere communication port for opening the tank to atmosphere. The connecting unit has a downstream side connected to the liquid discharging port. The atmosphere communication port has an opening/closing unit capable of switching the atmosphere communication port between open state and closed state and configured to switch the atmosphere communication port between open state and closed state in conjunction with switching of the connecting unit between disconnected state and connected state.

### BACKGROUND

### Field of the Technology

The present disclosure relates to a liquid ejection apparatus.

### Description of the Related Art

As a liquid ejection apparatus such as an inkjet printing apparatus, there is known a liquid ejection apparatus including a waste liquid tank for accommodating waste liquid. In a case of an inkjet printing apparatus, waste ink produced as a result of, e.g., a recovery operation for a liquid ejection head accommodated in the waste liquid tank.

Japanese Patent Laid-Open No. 2024-146984 discusses the configuration of a tank having an atmosphere communication port and a waste liquid inflow port on its side surface to prevent leakage of liquid even upon oblique insertion of a needle into the atmosphere communication port or the waste liquid inflow port.

Japanese Patent Laid-Open No. 2016-016606 discusses a configuration where an end of an ink circulation path can be detached from an ink container and connected to a waste liquid tank.

The technique discussed in Japanese Patent Laid-Open No. 2024-146984, however, describes deterioration in a case where the apparatus requires periodical discharge of the waste liquid accumulated in the cartridge (or the waste-liquid tank) and reattachment of the cartridge. Specifically, because a needle is repeatedly inserted and removed to and from a seal unit, the seal unit may deteriorate and permit waste liquid to leak. For this reason, what is demanded of a waste liquid tank that requires periodical attachment/detachment work is mitigation of deterioration of the seal unit, i.e., improvement in reliability.

### SUMMARY

An aspect of the present disclosure is directed to a liquid ejection apparatus having a liquid storage tank improved in reliability by mitigation of deterioration caused by tank attachment/detachment work.

An aspect of the present disclosure provides a liquid ejection apparatus that includes a first tank configured to store liquid; a first liquid flow channel configured for discharge of the liquid into the first tank; and a connecting unit configured to disconnect the first tank from the first liquid flow channel in a disconnected state and connect the first tank to the first liquid flow channel in a connected state. The first tank includes a waste liquid port for discarding the liquid stored in the first tank and a cap for closing the waste liquid port. The cap includes a liquid discharging port for receiving liquid from the first liquid flow channel and an atmosphere communication port for exhausting the first tank to atmosphere. A downstream side of the connecting unit is connected to the liquid discharging port and an upstream side of the connecting unit is connected to the first liquid flow channel, for flow between the first liquid flow channel and the first tank. The atmosphere communication port includes an opening/closing unit configured to switch the atmosphere communication port between an open state and a closed state. The opening/closing unit is configured to switch the atmosphere communication port between the open state and the closed state in conjunction with the connecting unit switching between the disconnected state and the connected state.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram showing an example schematic configuration of a liquid ejection apparatus;

FIG. 2 is a diagram showing a flow channel configuration in a print module;

FIG. 3 is a perspective view showing the outer appearance near a waste liquid tank unit in a housed position;

FIG. 4 is a diagram showing a state where a tank tray is located inside the main body of the liquid ejection apparatus;

FIG. 5 is a perspective view of the tank removed from the tank tray;

FIG. 6 is a perspective view of the tank with a cap on;

FIG. 7 is a perspective view of the tank with the cap off;

FIGS. 8A and 8B are diagrams illustrating a mechanism for closing an atmosphere communication port with a liquid flow channel disconnected;

FIGS. 9A and 9B are diagrams illustrating a mechanism for opening the atmosphere communication port with the liquid flow channel connected;

FIG. 10 is a diagram showing connection between a discard tank and a sub-tank;

FIG. 11 is a functional block diagram showing a control configuration of the liquid ejection apparatus;

FIG. 12 is a diagram showing a state where the waste liquid tank tray has been pulled out from the main body of the liquid ejection apparatus;

FIG. 13 is a diagram showing removal of the waste liquid tank from the waste liquid tank tray;

FIG. 14 is a diagram showing a connection state of the waste liquid tank and the waste liquid flow channel;

FIG. 15 is a diagram showing a connection state of the waste liquid tank and the waste liquid flow channel;

FIG. 16 is a perspective view showing a state where the waste liquid tank is housed in the waste liquid tank tray;

FIGS. 17A and 17B are diagrams showing the operation in which the waste liquid tank tray is housed into the main body of the liquid ejection apparatus;

FIGS. 18A and 18B are diagrams showing the operation in which the waste liquid tank tray is housed into the main body of the liquid ejection apparatus;

FIGS. 19A and 19B are top views of the waste liquid tank tray; and

FIGS. 20A and 20B are schematic diagrams of a mechanism for detecting that the flow channel is in a connected state.

### DESCRIPTION OF THE EMBODIMENTS

Example embodiments of the present disclosure are described below with reference to the drawings. The embodiments below are provided as examples and do not limit the present disclosure, with every combination of features described in the following embodiments not necessarily being essential as the solutions provided by the present disclosure. In the drawings, the same reference number is used to denote the same constituent.

### First Embodiment

### Overall Configuration of Liquid Ejection Apparatus

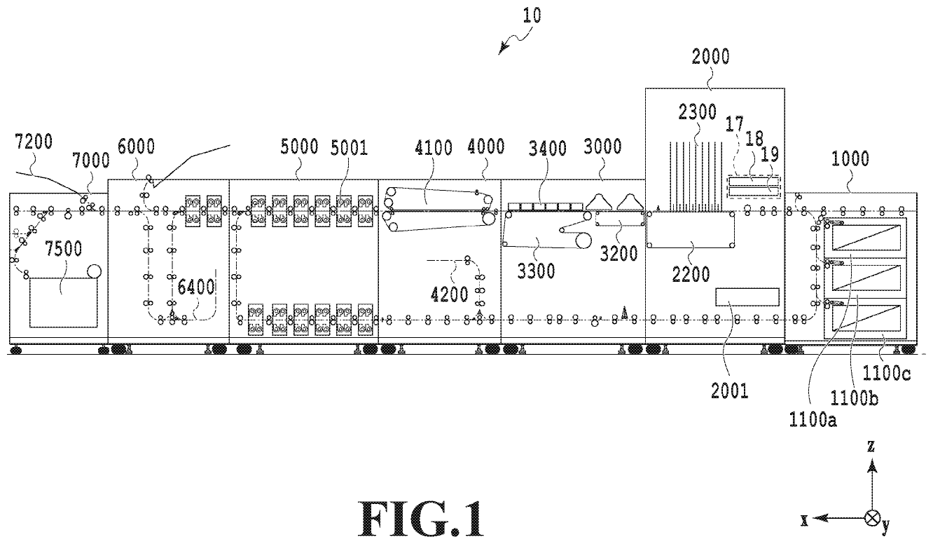

FIG. 1 is a schematic diagram showing an example schematic configuration of the liquid ejection apparatus. In the present embodiment, an inkjet printing apparatus 10 is an example of the liquid ejection apparatus. This inkjet printing apparatus 10 is a sheet-fed inkjet printing apparatus that outputs a printed object by forming an ink image on a sheet S using two types of liquid: reaction liquid and ink. In the present embodiment, the coordinate axes shown in FIG. 1 are used and described as a +x-direction, a +y-direction, and a +z-direction, respectively.

The inkjet printing apparatus 10 of the present embodiment has a paper feed module 1000, a print module 2000, a drying module 3000, a fixation module 4000, a cooling module 5000, an inversion module 6000, and a paper discharge and stack module 7000. The sheet S in the shape of a cut sheet is supplied from the paper feed module 1000, conveyed along a conveyance path, subjected to processes by the modules, and discharged to the paper discharge and stack module 7000.

In the paper feed module 1000, three storages 1100a to 1100c for accommodating sheets S are disposed. The storages 1100a to 1100c are each configured to be drawable to the front side of the apparatus. The sheets S are fed one sheet at a time from each of the storages 1100a to 1100c by a separation belt and conveyance rollers and conveyed to the print module 2000. The present disclosure is not limited to having three storages 1100a to 1100c and may be configured having one or two storages or four or more storages.

The print module 2000 has a pre-image-formation registration correction unit, a print belt unit 2200, a print unit 2300, a maintenance unit 17, and a waste liquid tank unit 2001. The sheet S conveyed from the paper feed module 1000 is corrected in the sheet's tilt and position by the pre-image-formation registration correction unit and is conveyed to the print belt unit 2200. The print unit 2300 is disposed at a position facing the print belt unit 2200 across the conveyance path of the sheet S. The print unit 2300 forms an image on the sheet S conveyed thereto by performing a printing process on the sheet S from above using a liquid ejection head. The sheet S is given clearance from the liquid ejection head by being suctioned onto and conveyed by the print belt unit 2200. Also, a plurality of the liquid ejection heads are arranged side by side in the conveyance direction. The waste liquid tank unit 2001 is further described herein.

The print unit 2300 of the present embodiment has a total of five line-type liquid ejection heads corresponding to four colors, Y (yellow), M (magenta), C (cyan), and Bk (black), and P (reaction liquid). The number of colors and the number of liquid ejection heads are not limited to five. Examples of an inkjet method that can be employed include a method using heat generation elements, a method using piezoelectric elements, a method using electrostatic elements, and a method using MEMS elements. An ink of each color is supplied to the corresponding liquid ejection head from an ink tank through an ink tube.

The sheet S printed by the print unit 2300 is conveyed by the print belt unit 2200. An inline scanner is disposed downstream of the print unit 2300 in the conveyance direction to detect displacement and color density of the image formed on the sheet S so that correction can be made for the printed image.

The drying module 3000 has a decoupling unit 3200, a drying belt unit 3300, and a hot air blowing unit 3400. The drying module 3000 is a unit that reduces a liquid component contained in the ink applied to the sheet S by the print unit 2300 to enhance the fixation between the sheet S and the ink. The sheet S printed in the print unit 2300 of the print module 2000 is conveyed to the decoupling unit 3200 disposed in the drying module 3000. In the decoupling unit 3200, the sheet S can be conveyed due to wind pressure from above and friction against the belt, and the sheet S is weakly held onto the belt so as not to be displaced on the print belt unit 2200, where an ink image is formed. The sheet S conveyed from the decoupling unit 3200 is suctioned onto and conveyed by the drying belt unit 3300 and at the same time, receives hot air from the hot air blowing unit 3400 disposed above the belt. The ink application surface of the sheet S is thereby dried. The drying method, the method using application of hot air may be combined with a method using application of electromagnetic waves (such as ultraviolet or infrared rays) to the surface of the sheet S or a heat conduction method bringing a heat generator into contact.

The fixation module 4000 has a fixation belt unit 4100. The fixation module 4000 has an upper belt unit and a lower belt unit. The sheet S conveyed from the drying module 3000 is passed through between the heated upper and lower belt units, so that the ink can be fixed onto the sheet S.

The cooling module 5000 has a plurality of cooling units 5001. The cooling units 5001 cool the hot sheet S conveyed from the fixation module 4000. The cooling units 5001 cool the sheet S by taking outside air into a cooling box using a fan to increase the pressure inside the cooling box and blowing air discharged from nozzles formed in a conveyance guide against the sheet S. The cooling units 5001 are disposed at both sides of the conveyance path to be able to cool the sheet S from both sides. Also, the cooling module 5000 has an internal conveyance path switch unit to switch the conveyance path of the sheet S depending on whether the sheet S is to be conveyed to the inversion module 6000 or to a double-side conveyance path used for double-sided printing. In double-sided printing, the sheet S is conveyed to a conveyance path below the cooling module 5000 and is further conveyed along the double-side conveyance path through the fixation module 4000, the drying module 3000, the print module 2000, and the paper feed module 1000. In the print module 2000, the sheet S is conveyed along a double-side conveyance path 2500. Then, the sheet S is conveyed through the pre-image-formation registration correction unit, the print belt unit 2200, and the print unit 2300 in the print module 2000 again and printed by the printing unit. A double-side conveyance unit of the fixation module 4000 is provided with an inversion unit 1 (4200) for inverting the sheet S upside down.

The inversion module 6000 has an inversion unit 2 (6400) and can invert the sheet S conveyed thereto upside down using the inversion unit 2 (6400) and can freely change which surface of the sheet S faces upward upon discharge.

The paper discharge and stack module 7000 has a top tray 7200 and a stacker 7500 and aligns and stacks the sheets S conveyed from the inversion module 6000.

The maintenance unit 17 includes mechanisms for restoring the ejection performance of the liquid ejection heads. Examples of such mechanisms include a capping mechanism that protects an ink ejection surface of each liquid ejection head, a wiper mechanism that wipes the ink ejection surface, and a suction mechanism that suctions ink in the liquid ejection head from the ink ejection surface using negative pressure. Also, the maintenance unit 17 is provided with driving mechanisms and rails. Then, the maintenance unit 17 is configured to reciprocate horizontally along the rails, and the maintenance unit 17 moves to a position immediately under the liquid ejection heads in performing maintenance of the liquid ejection heads and moves to a position retracted from the position immediately under the liquid ejection heads in not performing maintenance. The maintenance unit 17 has a capping tray 18 including capping mechanisms and a cleaning tray 19 including wiper mechanisms and suction mechanisms. The capping tray 18 and the cleaning tray 19 are configured to be able to reciprocate horizontally independently of each other using the driving mechanisms and the rails. In capping the liquid ejection heads with the capping mechanisms, only the capping tray 18 may move, or the entire maintenance unit 17 including the cleaning tray 19 may move.

### Flow Channel Configuration

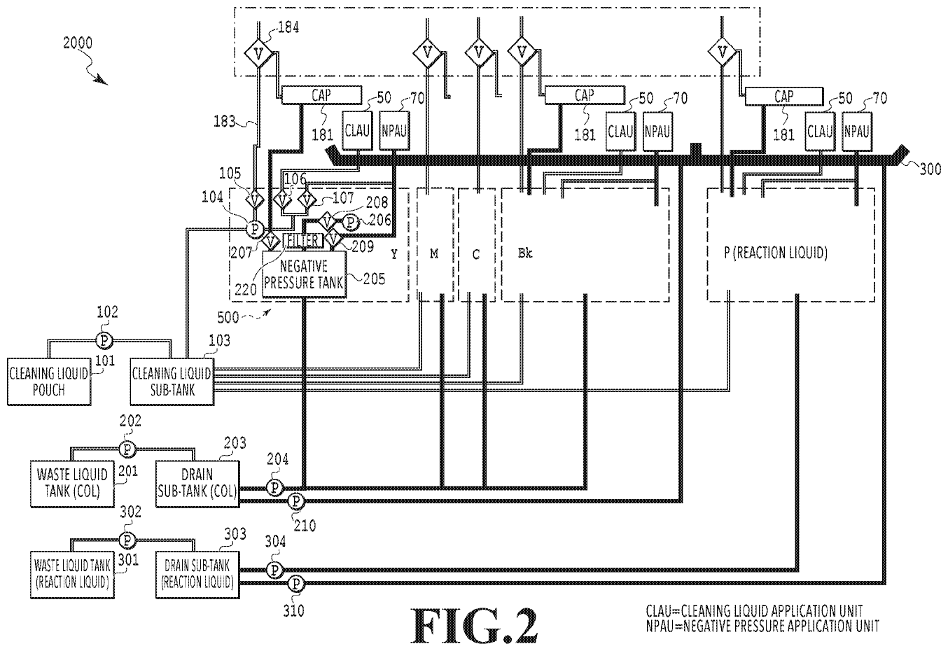

FIG. 2 is a diagram showing a flow channel configuration in the print module 2000 of the present embodiment. FIG. 2 is used to describe cleaning liquid supply channels, negative pressure suction flow channels, and waste liquid flow channels. All the configurations shown in FIG. 2 are provided in the print module 2000. Cleaning liquid and negative pressure supply units 500 are provided for the respective liquid ejection heads. For the sake of simplicity, FIG. 2 shows the internal configuration of only the cleaning liquid and negative pressure supply unit 500 for yellow (Y). Similarly, while a capping mechanism 181, a cleaning liquid application unit 50, and a negative pressure application unit 70 are provided for each liquid ejection head, FIG. 2 shows configurations only for some of the liquid ejection heads for the sake of simplicity. The cleaning liquid and negative pressure supply unit 500 has a cleaning liquid supply pump 104, on-off valves 105 to 107, a negative pressure tank 205, a negative pressure suction pump 206, on-off valves 207 to 209, and a filter 220.

Cleaning liquid is delivered from a cleaning liquid pouch 101 to a cleaning liquid sub-tank 103 by a pump 102. Each of the cleaning liquid and negative pressure supply units 500 (Y, M, C, Bk, P) for the respective liquid ejection heads is provided with the cleaning liquid supply pump 104. By the cleaning liquid supply pump 104 provided in the cleaning liquid and negative pressure supply unit 500 (Y, M, C, Bk, P) for the corresponding head, the cleaning liquid can be delivered from the cleaning liquid sub-tank 103 to the capping mechanism 181, the cleaning liquid application unit 50, and the negative pressure application unit 70. For instance, the cleaning liquid in the cleaning liquid sub-tank 103 can be delivered by the cleaning liquid supply pump 104 for Y to the capping mechanism 181, the cleaning liquid application unit 50, and the negative pressure application unit 70 corresponding to the liquid ejection head for Y.

Also, timing to supply the cleaning liquid to the capping mechanism 181, the cleaning liquid application unit 50, and the negative pressure application unit 70 can be controlled using the on-off valves 105 to 107.

Application of negative pressure to the capping mechanism 181 and the negative pressure application unit 70 is done by the negative pressure suction pump 206 connected to the negative pressure tank 205. Negative pressure can be applied to the capping mechanism 181 and the negative pressure application unit 70 via the negative pressure tank 205, using the on-off valves 207 to 209 provided. Because the cleaning liquid and negative pressure supply unit 500 is provided for each liquid ejection head, the application of negative pressure to the liquid ejection heads can also be performed independently of one another.

Waste liquid suctioned from the liquid ejection head as a result of negative pressure suction by the capping mechanism 181 and the negative pressure application unit 70 is accommodated from the negative pressure tank 205 into a drain sub-tank (COL) 203 by a pump 204 (also referred to as a second pump). Then, the waste liquid is further stored in a waste liquid tank (COL) 201 by a pump 202 (also referred to as a first pump).

Also, a collection tray 300 is provided to collect cleaning liquid overflowing from the cleaning liquid application units 50. The cleaning liquid collected by the collection tray 300 is delivered to the drain sub-tank (COL) 203 by a pump 210. (COL) means a channel/tank system for handling waste liquid of color ink (Y/M/C/Bk), not for handling waste liquid of reaction liquid (P).

Once the amount of waste liquid in the waste liquid tank (COL) 201 nears the upper-limit capacity, a waste liquid tank detection sensor detects this and urges a user to replace the waste liquid tank (COL) 201.

Waste liquid from the head for reaction liquid (P) is housed in a drain sub-tank (reaction liquid) 303 for the reaction liquid by a pump 304, separately from the waste liquid flow channels for the color ink heads (COL: Y to Bk). The waste liquid from the head for reaction liquid (P) is then stored in a waste liquid tank (reaction liquid) 301 for the reaction liquid by a pump 302. Also, the collection tray 300 is partitioned between the reaction liquid head and the color ink heads, and the cleaning liquid used for the reaction liquid head and collected by the collection tray 300 is delivered to the drain sub-tank (reaction liquid) 303 by a pump 310. Thus, the reaction liquid (P) and the color inks (Y to Bk) do not mix in the waste flow channels, which helps prevent the inks from solidifying and attaching to the flow channels and clogging the flow channels. The configuration of the collection tray 300 is not limited to the above, and separate trays may be provided for the color inks (Y to Bk) and the reaction liquid (P).

In the above described flow channel configuration, the cleaning liquid and negative pressure supply units 500 (Y, M, C, Bk, P) are provided for the respective heads. Each cleaning liquid and negative pressure supply unit 500 is provided with the cleaning liquid supply pump 104 and the on-off valves 105 to 107 for controlling supply of the cleaning liquid to each flow channel. Each cleaning liquid and negative pressure supply unit 500 is also provided with the negative pressure tank 205, the negative pressure suction pump 206 for negative pressure suction, and the on-off valves 207 to 209 for controlling application of negative pressure to each unit. In this way, in the present embodiment, necessary electronic devices and on-off valves are unitized for each of the cleaning liquid and negative pressure supply units 500 (Y, M, C, Bk, P) for the respective heads.

### Configuration of Waste Liquid Tank Unit

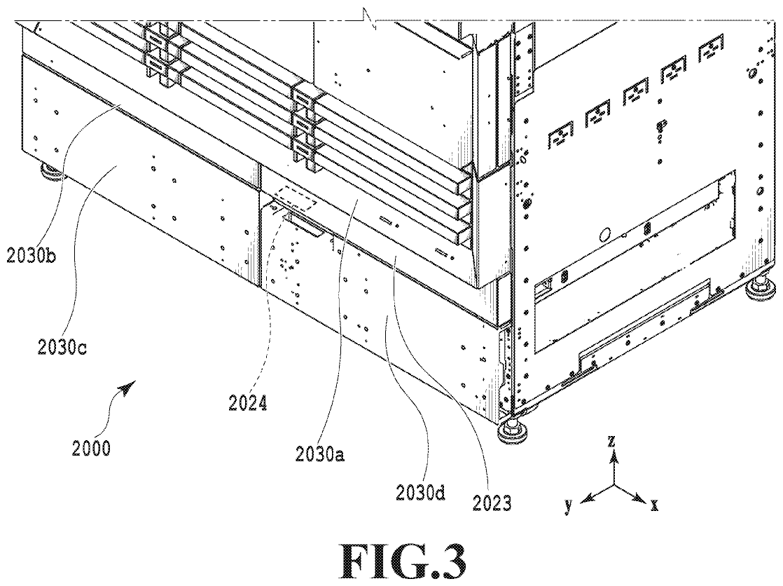

FIG. 3 is a perspective view showing an outer appearance near the waste liquid tank unit 2001 in housed position. As shown in FIG. 3, the print module 2000 has a tank unit cover 2023 for the waste liquid tank unit 2001. The print module 2000 also has, near the tank unit cover 2023, an upper cover 2030a, a left cover 2030b, a lower left cover 2030c, and a lower right cover 2030d. With the waste liquid tank unit 2001 housed in the print module 2000 of the inkjet printing apparatus 10, the tank unit cover 2023 is disposed at substantially the same position as the other covers 2030a to 2030d of the print module 2000 in terms of the sheet width direction. By operation of a tray handle unit 2024 provided at the tank unit cover 2023, a waste liquid tank tray 410, as described herein, can be drawn from a position where it is housed in the inkjet printing apparatus 10 to a position where the waste liquid tanks (201, 301) can be replaceable. In other words, the waste liquid tank tray 410 is separable from the main body of the inkjet printing apparatus 10.

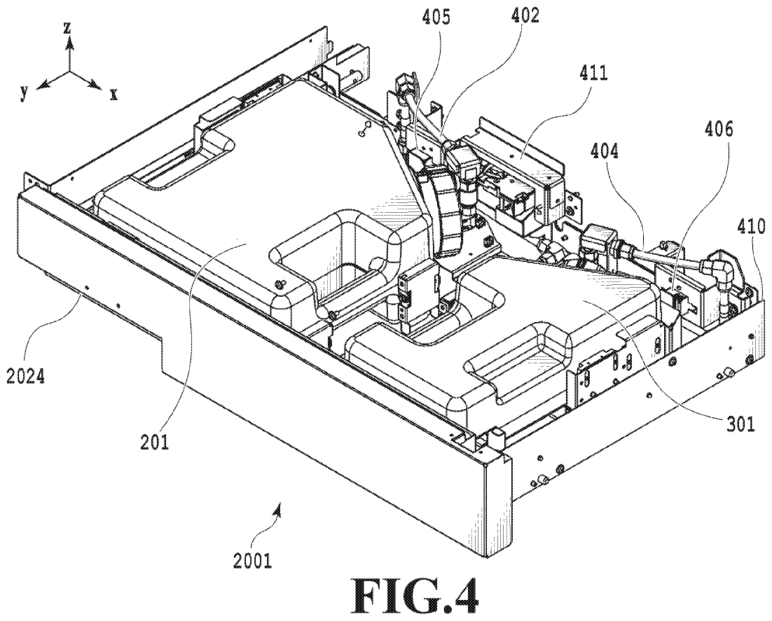

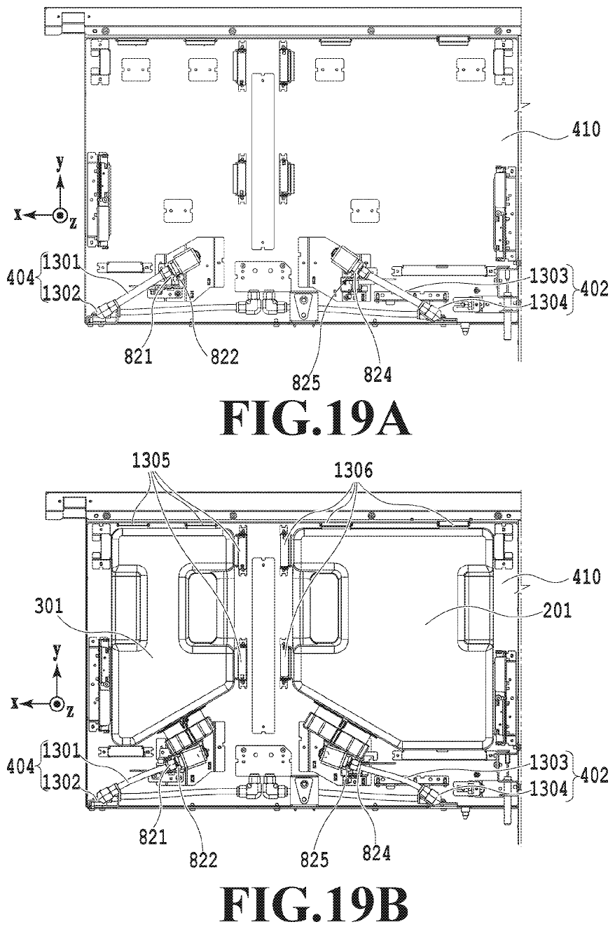

Next, an example where a waste color liquid tank 201 and a waste reaction liquid tank 301 are housed inside the waste liquid tank tray 410 of the waste liquid tank unit 2001 is demonstrated as the present embodiment. FIG. 4 is a perspective view showing a state where the waste liquid tank unit 2001 is housed inside the main body of the inkjet printing apparatus 10. The waste color liquid tank 201 and the waste reaction liquid tank 301 are housed in the waste liquid tank tray 410 and fixed by waste liquid tank positioning springs 1305 (described with reference to FIG. 19B). In other words, the waste liquid tank tray 410 is a support unit for the waste color liquid tank 201 and the waste reaction liquid tank 301. The waste liquid tank tray 410 is hereinafter also referred to as a support unit. Also, the waste color liquid tank 201 and the waste reaction liquid tank 301 may be collectively referred to as a first tank.

A waste color liquid flow channel 402 is connected to the waste color liquid tank 201, and a waste reaction liquid flow channel 404 is connected to the waste reaction liquid tank 301. The waste color liquid flow channel 402 and the waste reaction liquid flow channel 404 are collectively referred to as a first liquid flow channel. The waste color liquid flow channel 402 is a flow channel for discharging waste liquid to the waste color liquid tank 201 through a waste color liquid upstream coupling 901 and a waste color liquid tank coupling 603. The waste reaction liquid flow channel 404 is a flow channel for discharging waste liquid to the waste reaction liquid tank 301 through a waste reaction liquid upstream coupling 923 and a waste reaction liquid tank coupling 623. Waste liquid used for maintenance of a liquid ejection head (printhead) passes through a corresponding one of the waste color liquid flow channel 402 and the waste reaction liquid flow channel 404 and stored in a corresponding one of the waste color liquid tank 201 and the waste reaction liquid tank 301. A waste color liquid flow channel detection sensor 405 is disposed near the waste color liquid flow channel 402, and a waste reaction liquid flow channel detection sensor 406 is disposed near the waste reaction liquid flow channel 404. The waste color liquid flow channel detection sensor 405 and the waste reaction liquid flow channel detection sensor 406 are each capable of detecting, through a detection member, that the corresponding flow channel is normally connected and that the waste liquid tank tray 410 is located at the proper position. The waste color liquid flow channel 402 and the waste reaction liquid flow channel 404 are collectively referred to as a first liquid flow channel. Also, the waste color liquid flow channel detection sensor 405 and the waste reaction liquid flow channel detection sensor 406 are collectively referred to as a detection sensor. Details of a detection mechanism will be described later.

The present embodiment describes an example where the liquid ejection apparatus has two tanks, but the present disclosure is not limited to this. There may be one tank or three or more tanks. Also, the configuration of the present embodiment may be applied to all of the tanks or some of the tanks.

### Configuration of Waste Liquid Tank

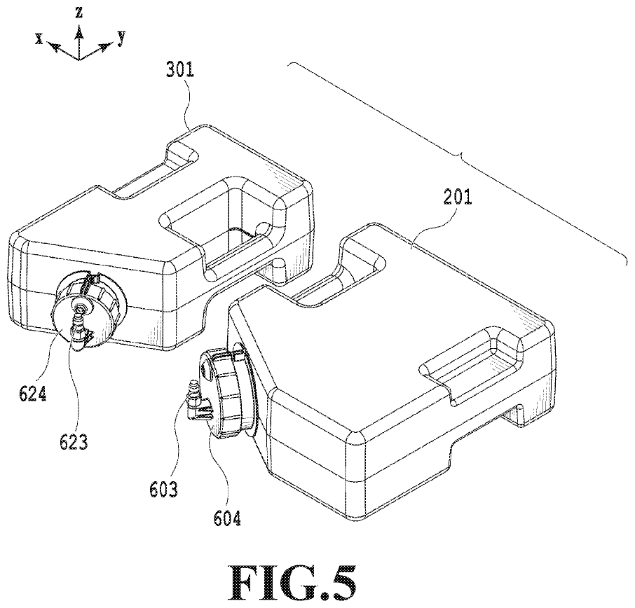

FIG. 5 is a perspective view of the waste color liquid tank 201 and the waste reaction liquid tank 301 removed from the main body of the inkjet printing apparatus 10. Waste liquids collected from the liquid ejection heads are stored in the waste color liquid tank 201 and the waste reaction liquid tank 301. As shown in FIG. 5, the waste color liquid tank 201 and the waste reaction liquid tank 301 have the same configuration. Thus, the present embodiment is described below using the waste color liquid tank 201. In the present embodiment, the waste color liquid tank 201 is referred to as a first tank 201 below.

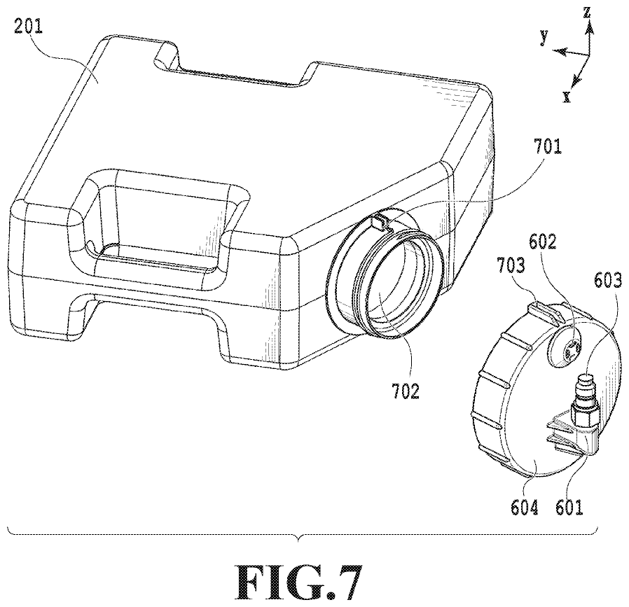

The first tank 201 has a cap 604 and a tank coupling 603 (also referred to as a first connecting member). The cap 604 is for closing a waste liquid port 702 (described with reference to FIG. 7). The cap 604 is provided at a side surface of the first tank 201 in a state where the first tank 201 is housed in the waste liquid tank tray 410 (FIG. 4). In other words, the cap 604 is provided at a side surface of the first tank 201 in a state where the first tank 201 is housed in the main body of the inkjet printing apparatus 10. The tank coupling 603 is provided at the cap 604. By removal of the cap 604, liquid stored in the first tank 201 can be easily discharged to the outside of the tank through the waste liquid port 702 to be described later. Also, the tank coupling 603 is attached and fixed to the cap 604. In other words, the cap 604 is integral with the tank coupling 603. The provision of the cap 604 to the first tank 201 facilitates waste liquid discharge work. Also, the provision of the cap 604 at a side surface of the first tank 201 allows the first tank 201 housed in the waste liquid tank tray 410 to have a low height. The space saving in the height direction is advantageous for housing the first tank 201 in the main body of the inkjet printing apparatus 10. The tank coupling 603 (the first connecting member) herein refers not only to a portion of connection with the upstream coupling 901, but also to a portion of connection with the cap 604.

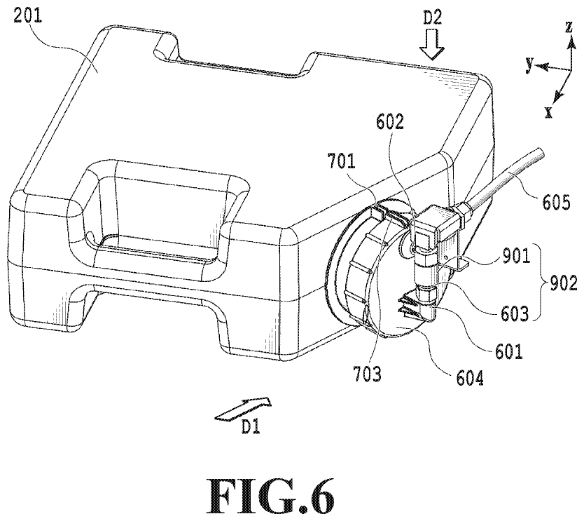

FIG. 6 is a perspective view of the first tank 201 with the tank coupling 603 and the upstream coupling 901 being connected. The cap 604 has a liquid discharging port 601 and an atmosphere communication port 602. Liquid discharged from a first liquid flow channel 605 (waste liquid) can be taken into the first tank 201 through the liquid discharging port 601. Through the atmosphere communication port 602, the inside space of the first tank 201 can be opened to the atmosphere.

A downstream side of the tank coupling 603 is attached and fixed to the liquid discharging port 601, and an upstream side of the tank coupling 603 is connected to the upstream coupling 901 (also referred to as a second connecting member). A downstream side of the upstream coupling 901 can be connected to and disconnected from the tank coupling 603. An upstream side of the upstream coupling 901 is connected to a downstream side of the first liquid flow channel 605. Connecting the tank coupling 603 and the upstream coupling 901 forms a flow channel formed by, from the upstream side to the downstream side, the first liquid flow channel 605, the upstream coupling 901, the tank coupling 603, and the first tank 201. Thus, connecting the tank coupling 603 and the upstream coupling 901 makes it possible to establish a flow channel providing communication between the first liquid flow channel 605 and the first tank 201. The formation of the flow path enables waste liquid discharged from the first liquid flow channel 605 to be taken into first tank 201. In this way, the first liquid flow channel 605 is configured to be able to connect to and disconnect from the first tank 201. As the couplings, one that has a valve function such that the valve opens and allows liquid to flow therethrough only in a connected state is used. This prevents unexpected leakage of liquid from the tank and does not permit leakage of liquid from the upstream coupling 901 either. The term upstream coupling 901, i.e., the second connecting member, as used herein, includes not only a member for connecting to the tank coupling 603, but also a member for connecting to the first liquid flow channel 605.

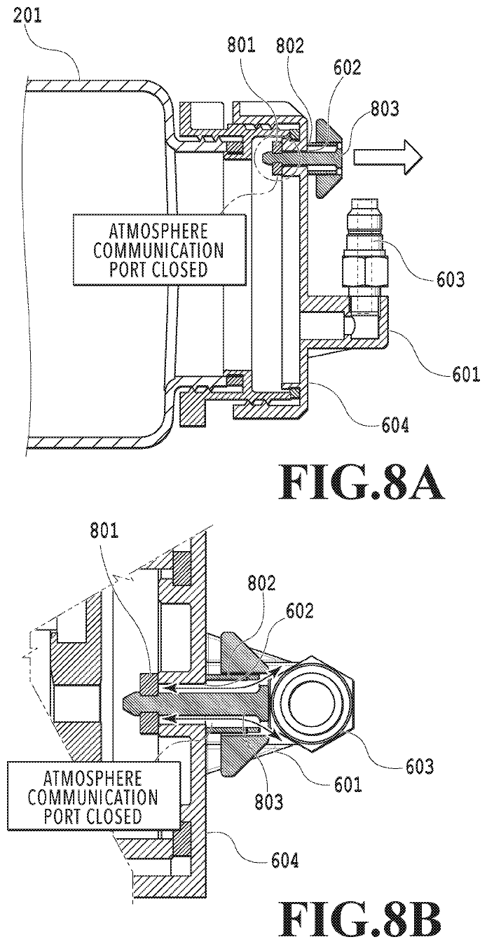

The tank coupling 603 (the first connecting member) and the upstream coupling 901 (the second connecting member) are together referred to as a connecting unit 902. In other words, the connecting unit 902 includes the tank coupling 603 (the first connecting member) and the upstream coupling 901 (the second connecting member). With the tank coupling 603 (the first connecting member) and the upstream coupling 901 (the second connecting member) connected, the connecting unit 902 can bring the first tank 201 and the first liquid flow channel 605 (the first liquid flow channel) into a connected state. With the tank coupling 603 (the first connecting member) and the upstream coupling 901 (the second connecting member) disconnected, the connecting unit 902 can bring the first tank 201 and the first liquid flow channel 605 (the first liquid flow channel) into a disconnected state. Arrows D1 and D2 in FIG. 6 are described later with reference to FIGS. 8A, 8B, 9A, 9B, and 10.

FIG. 7 is a perspective view of the first tank 201 with the upstream coupling 901 disconnected from the tank coupling 603 and the cap 604 removed. The first tank 201 has the waste liquid port 702. The waste liquid port 702 is provided at a side surface of the first tank 201 in a state where the first tank 201 is housed in the waste liquid tank tray 410 (FIG. 4). In other words, the waste liquid port 702 is provided at a side surface of the first tank 201 in a state where the first tank 201 is housed in the main body of the inkjet printing apparatus 10. The cap 604 can close the waste liquid port 702 of the first tank 201. In a case where the first tank 201 is housed in the waste liquid tank tray 410, naturally, the waste liquid port 702 is closed by the cap 604.

Next, a description is given of positioning in attachment of the cap 604 to the first tank 201. As shown in FIG. 7, the first tank 201 has a first positioning portion 701. Meanwhile, the cap 604 has a second positioning portion 703. In a case where the cap 604 is attached to the first tank 201 to close the waste liquid port 702, the attachment position of the cap 604 can be determined by the positional relation between the first positioning portion 701 and the second positioning portion 703. In a case where the cap 604 is attached to the first tank 201 to close the waste liquid port 702, the second positioning portion 703 of the cap 604 abuts against the first positioning portion 701 of the first tank 201 in the rotational direction of the cap 604. The position at which the rotation of the cap 604 stops can thus be determined. Specifically, in a case where the cap 604 is attached to the first tank 201 to close the waste liquid port 702, the second positioning portion 703 abuts against the first positioning portion 701 in the rotational direction of the cap 604, and this determines the rotation stop position of the cap 604. This fixes the orientation of the cap 604 attached to the first tank 201 and closing the waste liquid port 702 with the first tank 201 housed in the waste liquid tank tray 410. In this state, the atmosphere communication port 602 is disposed upward of the liquid discharging port 601 in the direction of gravity. Specifically, the configuration is such that, in a state where the first tank 201 is capped and housed inside the main body of the inkjet printing apparatus 10, the cap 604 is orientated so that the atmosphere communication port 602 is located upward of the liquid discharging port 601 in the direction of gravity.

### Opening/Closing Operation of Atmosphere Communication Port

Next, a description is given of the opening/closing operation of the atmosphere communication port 602 while the inkjet printing apparatus 10 is in use. While the inkjet printing apparatus 10 is in operation and discharging liquid (waste liquid) to the first tank 201, the atmosphere communication port 602 needs to be open to prevent pressure inside the first tank 201 from increasing by flowing in of the liquid. By contrast, during work of discarding the liquid in the first tank 201 from the first tank 201 removed from the inkjet printing apparatus 10, the atmosphere communication port 602 needs to be closed to prevent the liquid from spilling from the atmosphere communication port 602. The present embodiment describes an example of a liquid ejection apparatus capable of switching closing and opening of the atmosphere communication port 602 in conjunction with switching of the connecting unit 902 between the disconnection state and the connection state.

FIGS. 8A and 8B are diagrams illustrating the mechanism of how the atmosphere communication port 602 closes once the connecting unit 902 is brought to the disconnected state. Specifically, FIGS. 8A and 8B are diagrams illustrating the mechanism of how the atmosphere communication port 602 is closed with the tank coupling 603 and the upstream coupling 901 being in the disconnected state. FIG. 8A is a side view of the first tank 201 as seen along the surface of the first tank 201 where the cap 604 is attached, showing a state where the atmosphere communication port 602 is closed with the connecting unit 902 in the disconnected state. Specifically, FIG. 8A is a diagram of the cap 604 and the connecting unit 902 as seen in the direction of arrow D1 in FIG. 6. FIG. 8B is a diagram showing a state where the atmosphere communication port 602 is closed with the connecting unit 902 in the disconnected state, as seen from above the first tank 201. Specifically, FIG. 8B is a diagram of the cap 604 and the connecting unit 902 as seen in the direction of arrow D2 (−z-direction) in FIG. 6.

As shown in FIGS. 8A and 8B, the atmosphere communication port 602 is provided with a movable member 803, a spring 802 (also referred to as an elastic member), and a seal member 801 (also referred to as a closure member). The movable member 803, the spring 802, and the seal member 801 can switch the atmosphere communication port 602 between an open state and a closed state. Thus, the movable member 803, the spring 802, and the seal member 801 constitute a mechanism for opening and closing the atmosphere communication port 602 (also referred to as an opening/closing unit). In other words, the mechanism for opening and closing the atmosphere communication port 602 includes the movable member 803, the spring 802, and the seal member 801.

A shaft-shaped portion of the movable member 803 is inserted through the atmosphere communication port 602. The seal member 801 is attached and fixed to an end portion of the movable member 803 inside the first tank 201. The shaft-shaped portion of the movable member 803 is inserted through the spring 802. The spring 802 is provided between part of the movable member 803 and a peripheral portion of the atmosphere communication port 602 on the outer side of the first tank 201. The spring 802 is provided to push the movable member 803 outward of the first tank 201 (in the direction of the arrow in FIG. 8A) with its biasing force.

As shown in FIG. 8A, with the tank coupling 603 and the upstream coupling 901 disconnected from each other, i.e., with the connecting unit 902 in the disconnected state, the movable member 803 is not subjected to mechanical action from the upstream coupling 901. Thus, with the biasing force of the spring 802, the movable member 803 is at a position projecting from the atmosphere communication port 602 in the direction of the arrow. In this event, the seal member 801 is in close contact with a peripheral portion of the atmosphere communication port 602 on the inner side of the first tank 201, thereby closing the atmosphere communication port 602. The double-pointed arrows in FIG. 8B indicate a state where the seal member 801 closes the atmosphere communication port 602 and a peripheral portion of the atmosphere communication port 602 at the inner side of the first tank 201. The position of the movable member 803 at which the atmosphere communication port 602 is closed by the movable member 803 projecting as shown in FIGS. 8A and 8B is hereinafter referred to as a closing position. The movement of the movable member 803 to the closing position described above occurs in conjunction with a user operation of bringing the connecting unit 902 from the connected state to the disconnected state.

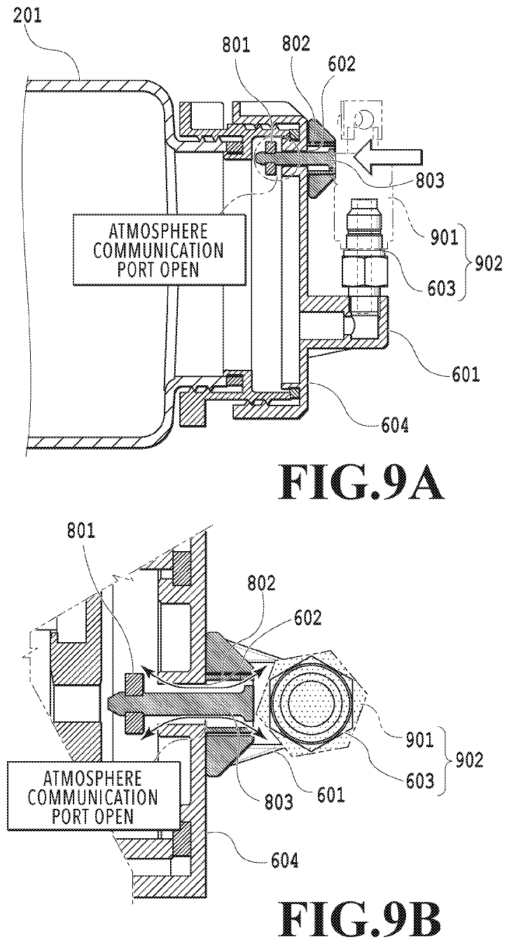

FIGS. 9A and 9B are diagrams illustrating the mechanism of how the atmosphere communication port 602 opens once the connecting unit 902 is brought to the connected state. Specifically, FIGS. 9A and 9B are diagrams illustrating the mechanism of how the atmosphere communication port 602 is opened with the tank coupling 603 and the upstream coupling 901 being in the connected state. FIG. 9A is a side view of the first tank 201 as seen along the surface of the first tank 201 where the cap 604 is attached, showing a state where the atmosphere communication port 602 is open with the connecting unit 902 being in the connected state. Specifically, FIG. 9A is a diagram of the cap 604 and the connecting unit 902 as seen in the direction of arrow D1 in FIG. 6. FIG. 9B is a diagram showing a state where the atmosphere communication port 602 is open with the connecting unit 902 in the connected state, as seen from above the cap 604. Specifically, FIG. 9B is a diagram of the cap 604 and the connecting unit 902 as seen in the direction of arrow D2 (the −z-direction) in FIG. 6.

As shown in FIG. 9A, with the connecting unit 902 in the connected state, the movable member 803 is subjected to mechanical action from the connecting unit 902 and is at a position where the movable member 803 is pushed in the direction of the arrow, i.e., in the direction toward the first tank. In other words, in a state where the tank coupling 603 and the upstream coupling 901 are connected to each other, the movable member 803 is at a position where it is pushed in the direction of the arrow or in the direction toward the first tank due to the mechanical action from the upstream coupling 901. In this state, the seal member 801 is away from the peripheral portion of the atmosphere communication port 602 on the inner wall of the cap 604 and has a gap from the first tank 201, thereby opening the atmosphere communication port 602. The double-pointed arrows in FIG. 9B indicate the state where the seal member 801 is away from the peripheral portion of the atmosphere communication port 602 on the inner wall of the cap 604, opening the atmosphere communication port 602. In this way, the mechanical action that the movable member 803 receives from the connecting unit 902 changes depending on whether the connecting unit 902 is in the disconnected state or in the connected state. The inkjet printing apparatus 10 is configured such that the movable member 803 moves between the closing position and the opening position due to this change and the biasing force of the spring 802. The position of the movable member 803 at which the atmosphere communication port 602 opens as a result of the movable member 803 being pushed in the direction toward the first tank as shown in FIGS. 9A and 9B is hereinafter referred to as an opening position. The movement of the movable member 803 to the opening position described above occurs in conjunction with a user operation of bringing the connecting unit 902 from the disconnected state to the connected state.

As described, the movable member 803 can move between the closing position and the opening position. Once the tank coupling 603 and the upstream coupling 901 are disconnected from each other, the movable member 803 moves to the closing position and closes the atmosphere communication port 602. Also, once the tank coupling 603 and the upstream coupling 901 are connected to each other, the movable member 803 moves to the opening position and opens the atmosphere communication port 602 due to the action from the upstream coupling 901, which is the second connecting member. Also, the spring 802 (the elastic member) is a member for moving the movable member 803 to the closing position and fixing the movable member 803 at its closing position using its biasing force while the tank coupling 603 and the upstream coupling 901 are disconnected from each other. The seal member 801 (the closure member) is a member for sealing the inside of the first tank 201 with the movable member 803 moved to the closing position. The seal member 801 is attached and fixed to the end portion of the movable member 803 to be located inside the first tank 201 with the movable member 803 being inserted in the atmosphere communication port 602.

The movable member 803, the spring 802, and the seal member 801 constitute the opening/closing mechanism. The opening/closing mechanism is configured to switch the atmosphere communication port 602 between the closed state and the open state in conjunction with switching of the connecting unit 902 between the disconnected state and the connected state, using a change in the mechanical action from the connecting unit 902. Due to this configuration, once the tank coupling 603 and the upstream coupling 901 are disconnected from each other, the movable member 803 moves to the closing position and closes the atmosphere communication port 602. Also, once the tank coupling 603 and the upstream coupling 901 are connected to each other, the movable member 803 moves to the opening position and opens the atmosphere communication port 602.

As described, the present embodiment can switch the atmosphere communication port 602 of the first tank 201 between the closed state and the open state in conjunction with whether the connecting unit 902 is in the disconnected state or the connected state. Thus, a needle does not need to be repeatedly inserted to and removed from the seal member in closing and opening of the atmosphere communication port 602. This prevents deterioration of the seal member and therefore leakage of liquid even for a liquid ejection apparatus that requires periodical discard of the liquid accumulated in the tank and reattachment of the tank. Thus, it is possible to provide a liquid ejection apparatus including a tank improved in reliability by mitigating deterioration caused by attachment and detachment of the tank for storing liquid.

Also, the atmosphere communication port 602 can be switched to the open state simply by housing the first tank 201 into the waste liquid tank tray 410 and bringing the connecting unit 902 to the connected state. In other words, it is possible to prevent a user from forgetting to open the atmosphere communication port 602. Also, the provision of the cap 604 to the first tank 201 facilitates the user's work for discarding waste liquid and therefore improves usability. Further, the provision of the cap 604 at a side surface of the first tank 201 can lower the height of the first tank 201 in a state where the first tank 201 is housed in the waste liquid tank tray 410. Thus, space saving in the height direction can also be achieved.

### Second Embodiment

The first embodiment describes an example of a liquid ejection apparatus improved in reliability by switching of the atmosphere communication port 602 of the first tank 201 between the closed state and the open state in conjunction with switching of the connecting unit 902 between the disconnected state and the connected state. The first embodiment further describes an example of a liquid ejection apparatus improved in useability with the provision of the cap 604 at a side surface of the first tank 201. The present embodiment describes an example of how a liquid ejection apparatus further including a second tank 203 upstream of the first tank 201 controls supply of liquid from the second tank 203 to the first tank 201. The following omits a description of a configuration similar to or corresponding to one in the first embodiment by denoting the configuration with the same reference numeral and mainly describes points different from the first embodiment.

### Control Configuration

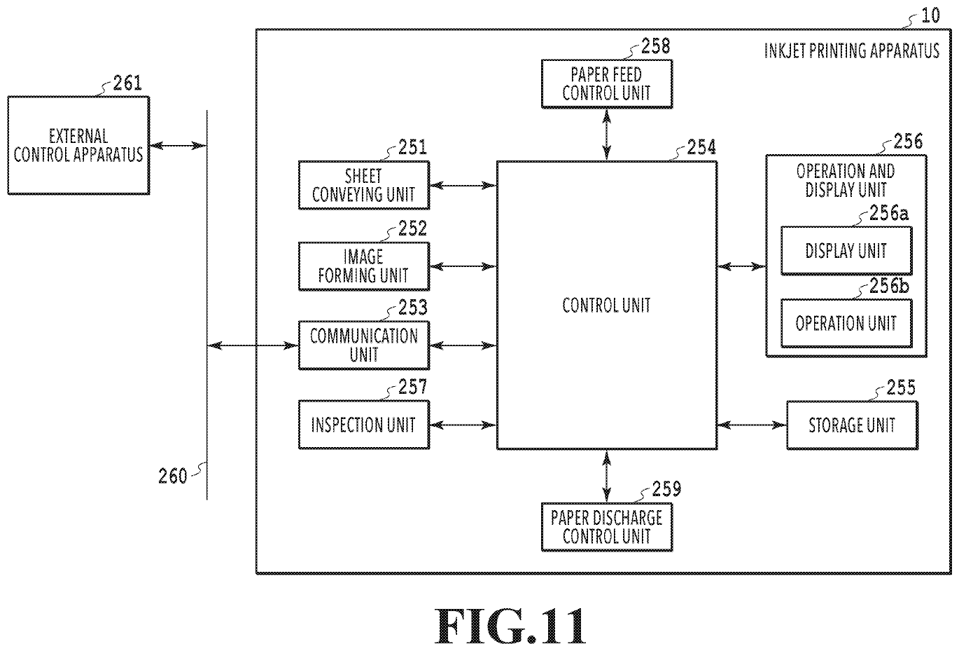

A control configuration for performing the control is described below. FIG. 11 is a functional block diagram showing a control configuration of the inkjet printing apparatus 10. The control configuration of the inkjet printing apparatus 10 is described in detail using FIG. 11. As shown in FIG. 11, the inkjet printing apparatus 10 includes a sheet conveying unit 251, an image forming unit 252, a communication unit 253, a control unit 254, a storage unit 255, an operation and display unit 256, an inspection unit 257, a paper feed control unit 258, and a paper discharge control unit 259.

The sheet conveying unit 251 is a mechanism for conveying the sheet S inside the inkjet printing apparatus 10. For example, the sheet conveying unit 251 conveys the sheet S that has been conveyed from the paper feed control unit 258, to the image forming unit 252 using a plurality of rollers and conveys the sheet S that has passed the image forming unit 252 to the paper discharge control unit 259. Based on print data that the inkjet printing apparatus 10 is instructed to print, the image forming unit 252 forms an image on the sheet S supplied from the paper feed control unit 258. The image forming unit 252 controls the print unit 2300. Using the print belt unit 2200, the image forming unit 252 conveys the sheet S having an image formed thereon. The communication unit 253 is configured by, for example, a communication control card such as a local area network (LAN) card. The communication unit 253 transmits and receives various kinds of data to and from an external control apparatus 261 (e.g., a personal computer) connected to a communication network 260 such as a LAN or a wide area network (WAN). The external control apparatus 261 is installed with, e.g., a printing application necessary for printing.

The control unit 254 has, for example, a central processing unit (CPU), random-access memory (RAM), and the like. The CPU of the control unit 254 reads any of various programs stored in the storage unit 255, such as system programs and processing programs, loads the program into the RAM, and executes processing according to the program loaded. For example, the control unit 254 can perform print processing for executing a print job in response to a user instruction. The storage unit 255 is configured by, for example, non-volatile semiconductor memory (what is called flash memory), a hard disk drive (HDD), or the like. What is stored in the storage unit 255 is various programs including system programs and processing programs executed by the control unit 254 and various kinds of data necessary for execution of the programs. The operation and display unit 256 is configured by, for example, a liquid crystal display (LCD) with a touch panel and includes a display unit 256a and an operation unit 256b.

The display unit 256a displays various kinds of information on the display screen according to a display control signal inputted from the control unit 254. The operation unit 256b includes various operation keys such as numeric keys and a start key, receives various input operations from a user, and outputs an operation signal to the control unit 254. For example, the operation and display unit 256 is used in execution of a job to, e.g., configure settings of job information. As the settings of job information, a user can freely set any of, for example, sheets to use, information on the print speed, the number of sheets to print, the number of copies to print, the print length, the print weight, and the print diameter.

### Example of Control by Liquid Ejection Apparatus

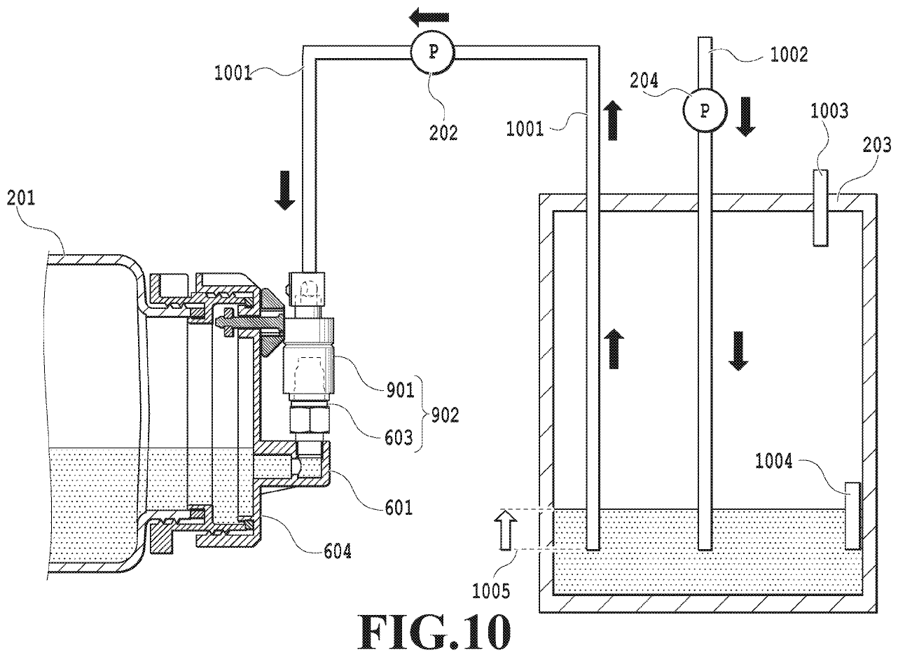

FIG. 10 is a diagram showing connection in a case where the second tank 203, a sub-tank, is provided upstream of the first tank 201, a discard tank. The inkjet printing apparatus 10 of the present embodiment includes the second tank 203, a first flow channel 1001, a second flow channel 1002, an atmosphere communication port 1003, a liquid detection unit 1004, a first pump 202, and a second pump 204. The inkjet printing apparatus 10 of the present embodiment is otherwise the same as that of the first embodiment. The first flow channel 1001 (FIG. 10) of the present embodiment is the same as the first liquid flow channel 605 (FIG. 6) of the first embodiment but is denoted with a different reference numeral because a pump 202 is provided on the flow channel in the present embodiment.

The second tank 203 is the drain sub-tank (COL) 203 described using FIG. 2. The second tank 203 is provided upstream of the first tank 201. The first tank 201 and the second tank 203 are connected by the first flow channel 1001. A downstream end portion of the first flow channel 1001 is connected to the upstream coupling 901, which is the second connecting member. The downstream end portion of the first flow channel 1001 is a liquid outflow port of the first flow channel 1001. An upstream end portion of the first flow channel 1001 is laid into the second tank 203. The upstream end portion of the first flow channel 1001 is a liquid inflow port of the first flow channel 1001.

The atmosphere communication port 1003 is provided at the upper surface of the second tank 203. In the operation of discharging liquid from the inkjet printing apparatus 10 to the second tank 203, the atmosphere communication port 1003 is opened to prevent pressure increase in the second tank 203 by flowing in of the liquid. The first pump 202 is provided on the first flow channel 1001 at a position between the first tank 201 and the second tank. The first pump 202 is a pump for supplying liquid to the first tank 201. The second pump 204 is provided on the second flow channel 1002 at a position upstream of the second tank. The second pump 204 is a pump for supplying liquid to the second tank 203.

The liquid detection unit 1004 is provided in the second tank 203. The liquid detection unit 1004 detects the liquid level inside the second tank 203. A sensor used as the liquid detection unit 1004 may detect not the liquid level, but the liquid quantity. A sensor that uses capacitance detection, detection by electric energization, detection by weight, float-type detection, or the like can be used as the liquid detection unit 1004. Although the present embodiment shows an example where the liquid detection unit 1004 is disposed inside the second tank 203, the liquid detection unit 1004 may be disposed outside the second tank 203.

As shown in FIG. 10, in a case where the liquid level of the liquid in the first tank 201 is higher than the liquid discharging port 601 of the first tank 201, the control unit 254 of the inkjet printing apparatus 10 of the present embodiment performs control so that the liquid level of the liquid in the second tank 203 will be higher in the direction of gravity than a position 1005 of the upstream end portion (liquid inflow port) of the first flow channel 1001. Unless the second tank 203 is empty of liquid, such as at the start of use of the second tank 203, the control unit 254 performs control so that the liquid level in the second tank 203 will always be higher than the position 1005 of the upstream end portion (the liquid inflow port) of the first flow channel 1001. This can prevent delivery of air into the liquid in the first tank 201. This as a result can prevent foaming of the liquid in the first tank 201 and leakage of foam from the cap 604.

### Third Embodiment

The first embodiment describes an example of a liquid ejection apparatus improved in reliability by switching of the atmosphere communication port 602 of the first tank 201 between the closed state and the open state in conjunction with switching of the connecting unit 902 between the disconnected state and the connected state. The first embodiment further describes an example of a liquid ejection apparatus improved in useability with the provision of the cap 604 at a side surface of the first tank 201. The present embodiment describes an example of a liquid ejection apparatus including a fail-safe mechanism for removal and insertion work of the liquid flow channel connecting the first tank. The following omits a description of a configuration similar to or corresponding to one in the first embodiment by denoting the configuration with the same reference numeral and mainly describes points different from the first embodiment.

### Overview

An overview of the third embodiment is described. A user of a liquid ejection apparatus such as an inject printing apparatus performs work of removing a waste liquid tank from the liquid ejection apparatus and discarding the liquid in the tank. In this event, in a case where the user who is conducting the work of disconnecting the flow channel makes a mistake in insertion or removal of the liquid flow channel, the waste liquid, which is ink, may leak outside the flow channel. Also, after discard of the liquid in the tank and re-housing of the tank, ink may leak outside the flow channel unless the flow channel is connected properly through couplings or the like. Thus, what is demanded of a liquid ejection apparatus is to include a fail-safe mechanism for detecting an operation mistake in the work of removal and insertion between the flow channel and the tank for storing liquid.

The present embodiment is directed to a liquid ejection apparatus including a fail-safe mechanism for the work of removal and insertion between a flow channel and a tank for storing liquid.

The liquid ejection apparatus according to an aspect of the present embodiment includes a tank for storing liquid, a liquid flow channel configured to be able to connect to and disconnect from the tank and to allow the liquid to flow into the tank, a second connecting member provided at a downstream end portion of the liquid flow channel, a first connecting member provided at the tank and connectable to the second connecting member to allow the liquid from the liquid flow channel to flow into the tank, and a detection unit configured to detect that the second connecting member and the first connecting member are in a connected state by detecting a detection member that changes its position in the event where the second connecting member and the first connecting member are connected to each other.

The present embodiment can provide a liquid ejection apparatus including a fail-safe mechanism for the work of removal and insertion between a flow channel and a tank for storing liquid.

### Configuration of the Waste Liquid Tank Unit

Although the embodiment described below has two waste liquid tanks, the present disclosure is not limited to this, and there may be a single waste liquid tank or three or more waste liquid tanks.

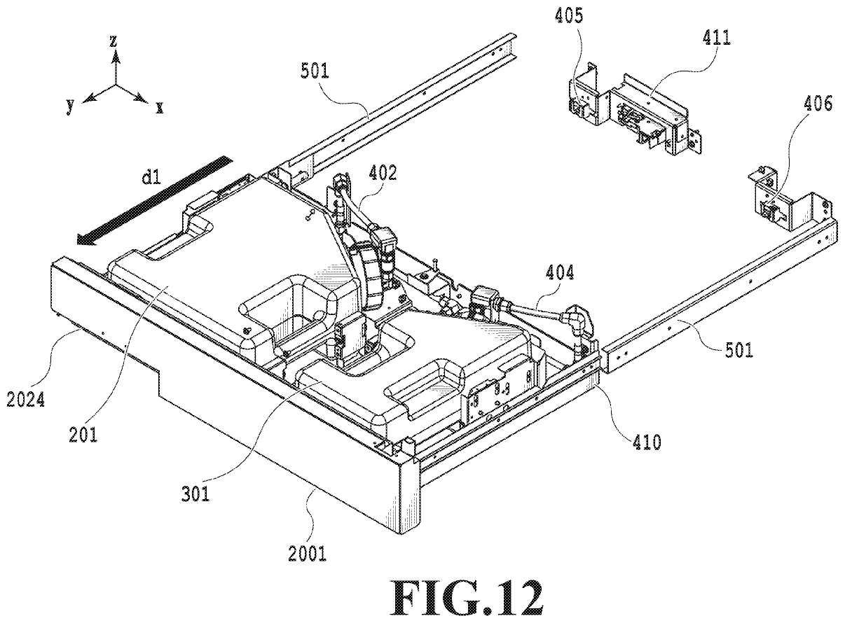

FIG. 12 is a diagram showing a state where the waste liquid tank tray 410 is pulled out of the main body of the inkjet printing apparatus 10. Because an extendable tank tray rail unit 501 is fixed to the waste liquid tank tray 410, the waste liquid tank tray 410 can be pulled out of the main body of the inkjet printing apparatus 10 in the direction denoted by arrow d1 (the +y-direction) by a grip of a tray handle unit 2024. In other words, the waste liquid tank tray 410 is separable from the main body of the inkjet printing apparatus 10. Meanwhile, the waste color liquid flow channel detection sensor 405, the waste reaction liquid flow channel detection sensor 406, and a tray retraction mechanism 411 are provided in the main body of the inkjet printing apparatus 10 and are therefore configured not to be pulled out along with the waste liquid tank tray 410.

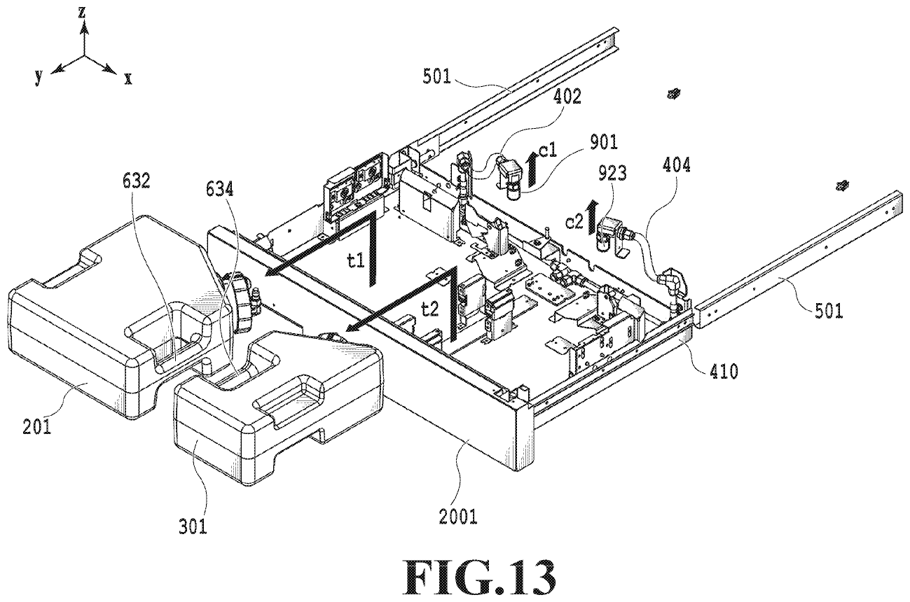

FIG. 13 is a diagram showing the procedure of removing the waste color liquid tank 201 and the waste reaction liquid tank 301 from the waste liquid tank tray 410. The waste liquid tank tray 410 is provided with the waste color liquid flow channel 402. The waste color liquid upstream coupling 901 is provided at a downstream end portion of the waste color liquid flow channel 402. The waste color liquid upstream coupling 901 and the waste reaction liquid upstream coupling 923 are collectively referred to as a second connecting member.

Because the waste color liquid flow channel 402 and the waste color liquid tank 201 are connected by couplings (flow channel connecting members), an operation of pulling the waste color liquid upstream coupling 901 off in the direction of arrow c1 (the +z-direction) can disconnect the waste liquid flow channel and the waste liquid tank from each other. In other words, the first liquid flow channel and the tank are configured such that they can be disconnected from each other. The waste color liquid tank 201 from which the waste color liquid flow channel 402 has been disconnected can be removed from the waste liquid tank tray 410 as indicated by arrow t1. Then, the waste color liquid tank 201 can be completely removed from the main body of the inkjet printing apparatus 10 to the outside of the apparatus. A waste color liquid tank handle unit 632 is provided for easy portability after the removal. The above-described configuration of the waste color liquid tank 201 and its surroundings is the same for the waste reaction liquid tank 301 as well.

The waste color liquid tank 201 and the waste reaction liquid tank 301 of the present embodiment have the same configurations as those of the first embodiment. An overview of the configurations of the waste color liquid tank 201 and waste reaction liquid tank 301 is described. FIG. 5 is a perspective view of the waste color liquid tank 201 and the waste reaction liquid tank 301 removed from the main body of the inkjet printing apparatus 10. The waste color liquid tank 201 and the waste reaction liquid tank 301 are for storing waste liquid collected from the liquid ejection heads. The waste color liquid tank 201 has the waste color liquid cap 604 and the waste color liquid tank coupling 603. The waste color liquid tank coupling 603 and the waste reaction liquid tank coupling 623 are collectively referred to as a first connecting member.

The waste color liquid tank coupling 603 is provided at the waste color liquid cap 604. With removal of the waste color liquid cap 604, the waste color liquid tank 201 can easily discharge waste color liquid stored in the waste color liquid tank 201 to the outside of the tank. The waste color liquid tank coupling 603 is attached and fixed to the waste color liquid cap 604. The waste color liquid tank coupling 603 can connect to the waste color liquid upstream coupling 901 to be described later. As the coupling, one that has a valve function such that the valve opens and allows liquid to flow therethrough only in a connected state is used. This prevents unexpected leakage of liquid from the waste liquid tank and does not permit leakage of liquid from the waste color liquid upstream coupling 901 either. The above-described configuration of the waste color liquid tank 201 is the same for the waste reaction liquid tank 301.

### Connection State Detection Mechanism

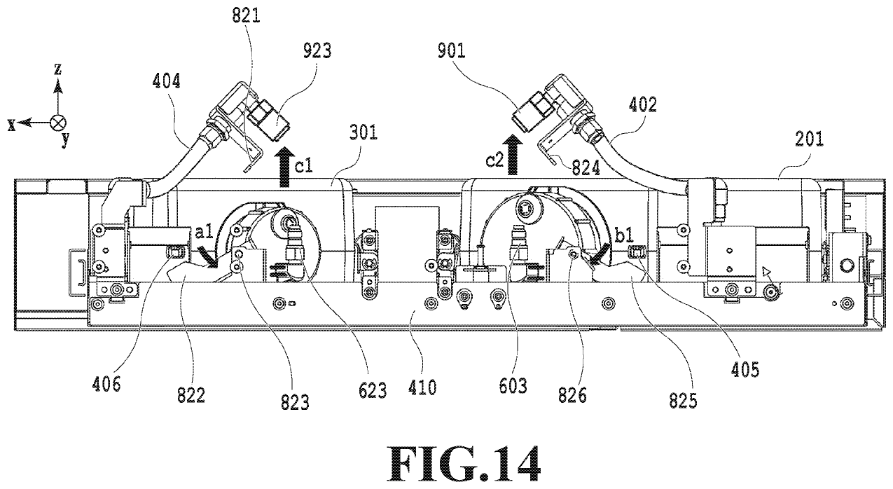

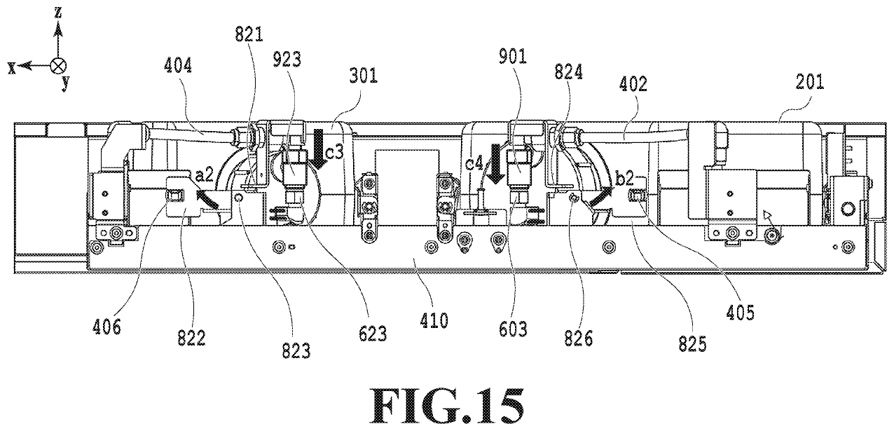

FIGS. 14 and 15 are diagrams showing connection states of the waste liquid tank and the waste liquid flow channel. FIG. 14 is a diagram of a state where the waste liquid tank coupling and the waste liquid upstream coupling are disconnected, and FIG. 15 is a diagram of a state where the waste liquid tank coupling and the waste liquid upstream coupling are connected.

FIG. 14 shows a state where the waste reaction liquid upstream coupling 923 has been pulled off in the direction of arrow c1 (the +z-direction). In other words, FIG. 14 shows a state where the waste reaction liquid upstream coupling 923 and the waste reaction liquid tank coupling 623 are disconnected (in the disconnected state). The waste reaction liquid upstream coupling 923 is connected to the downstream end portion of the waste reaction liquid flow channel 404. A waste reaction liquid flow-channel-side detection member 821 is provided at the waste reaction liquid upstream coupling 923. The waste reaction liquid flow-channel-side detection member 821 is away from a waste reaction liquid tray-side detection member 822 as a result of the waste reaction liquid upstream coupling 923 having been pulled off.

Meanwhile, the waste reaction liquid tray-side detection member 822 is provided at the waste liquid tank tray 410. The waste reaction liquid tray-side detection member 822 is disposed on the-y-side of the waste reaction liquid tank 301. The waste reaction liquid tray-side detection member 822 can rotate about a detection member shaft 823. Once the waste reaction liquid upstream coupling 923 is pulled off in the direction of c1 (+z-direction), the waste reaction liquid tray-side detection member 822 rotates and moves in the direction of arrow a1 due to its own weight. It is also possible to bias the waste reaction liquid tray-side detection member 822 using a spring to ensure that the waste reaction liquid tray-side detection member 822 moves in the direction of arrow a1 as the waste reaction liquid upstream coupling 923 is pulled off.

The waste reaction liquid flow channel detection sensor 406 shown in FIG. 14 is a silhouette of the waste reaction liquid flow channel detection sensor 406 provided to the inkjet printing apparatus 10, projected onto an xz-plane. The waste reaction liquid tray-side detection member 822 rotates in the direction of a1 and thereby moves to a position not overlapping with the silhouette. In this state, the waste reaction liquid tray-side detection member 822 is located outside of the detection range of the waste reaction liquid flow channel detection sensor 406. The position at which the waste reaction liquid tray-side detection member 822 is located after moving in the direction of arrow a1 as the waste reaction liquid upstream coupling 923 is pulled off is hereinafter referred to as a non-detection position. In a case where the waste reaction liquid tray-side detection member 822 is at the non-detection position, the state of the waste reaction liquid flow channel detection sensor 406 is unchanged. The non-detection position is a position different from the detection position to be described later. The connection state detection mechanism described above has the same configuration for the waste liquid tank, the couplings, the detection member, the sensor, and the like on the waste color liquid side and detects the connection state of the couplings based on a similar operation. The waste reaction liquid tray-side detection member 822 and a waste color liquid tray-side detection member 825 are collectively referred to as a first detection member, and the waste reaction liquid flow-channel-side detection member 821 and a waste color liquid flow-channel-side detection member 824 are collectively referred to as a second detection member. Further, the first detection member and the second detection member are also together referred to as a detection member.

FIG. 15 is, as described earlier, a diagram of the state where the waste liquid tank coupling and the waste liquid upstream coupling are connected. FIG. 15 shows a state where the waste reaction liquid upstream coupling 923 and the waste reaction liquid tank coupling 623 are connected (in the connected state) after the waste reaction liquid upstream coupling 923 is moved in the direction of c3 (the −z-direction) by a user operation. Specifically, to allow waste liquid to flow into and be stored in the waste reaction liquid tank 301, the waste reaction liquid upstream coupling 923 and the waste reaction liquid tank coupling 623 are connected by a user. As a result, a flow channel providing communication is established by, from the upstream side to the downstream side, the waste reaction liquid flow channel 404, the waste reaction liquid upstream coupling 923, the waste reaction liquid tank coupling 623, and the waste reaction liquid tank 301.

Connection between the waste reaction liquid upstream coupling 923 and the waste reaction liquid tank coupling 623 is locked due to the couplings' action toward each other. To disconnect the waste reaction liquid upstream coupling 923 and the waste reaction liquid tank coupling 623, the couplings need to be unlocked to release the connection. A method for the locking, for example, includes a spring mechanism, a cap nut, or the like provided at the couplings. The waste reaction liquid tank 301 is fixed in desired position on the waste liquid tank tray 410 due to its own weight and a bias from the waste liquid tank positioning springs 1305 (described later with reference to FIG. 19B). The waste reaction liquid tank coupling 623 is attached and fixed to the cap of the waste reaction liquid tank 301. Because the waste reaction liquid upstream coupling 923 is connected and locked to the waste reaction liquid tank coupling 623, the waste reaction liquid upstream coupling 923 is fixed at a predetermined position in the waste liquid tank tray 410. The waste reaction liquid tank 301 and the waste liquid tank tray 410 may be configured such that one of them has a boss shape for positioning and the other one has a hole so that positioning is achieved by fitting of the boss into the hole. Once the position of the waste reaction liquid tank 301 in the waste liquid tank tray 410 is determined, the waste reaction liquid flow-channel-side detection member 821 is fixed at a predetermined position in the waste liquid tank tray 410 as well. Then, the waste reaction liquid flow-channel-side detection member 821 is in contact with the waste reaction liquid tray-side detection member 822. The waste reaction liquid tray-side detection member 822 rotates and moves in the direction of arrow a2 due to the contact with the waste reaction liquid flow-channel-side detection member 821 and the mechanical action from the waste reaction liquid flow-channel-side detection member 821. In other words, the position of the detection member changes once the waste reaction liquid upstream coupling 923 (the second connecting member) and the waste reaction liquid tank coupling 623 (the first connecting member) are connected.

The waste reaction liquid flow channel detection sensor 406 shown in FIG. 15 is a silhouette of the waste reaction liquid flow channel detection sensor 406 provided to the inkjet printing apparatus 10, projected onto the xz-plane. The waste reaction liquid tray-side detection member 822 rotates and moves in the direction of a2 to a location overlapping with the silhouette. In this state, the waste reaction liquid tray-side detection member 822 is located inside of the detection range of the waste reaction liquid flow channel detection sensor 406. The position at which the waste reaction liquid tray-side detection member 822 is located after moving in the direction of arrow a2 into the detection range of the waste reaction liquid flow channel detection sensor 406 upon connection of the waste reaction liquid upstream coupling 923 and the waste reaction liquid tank coupling 623 is hereinafter referred to as a detection position. Once the waste reaction liquid tray-side detection member 822 rotates and moves to the detection position, the waste reaction liquid flow channel detection sensor 406 detects this. Specifically, the position of the detection member changes once the waste reaction liquid upstream coupling 923 (the second connecting member) and the waste reaction liquid tank coupling 623 (the first connecting member) are connected, and the waste reaction liquid flow channel detection sensor 406 detects this. The detection position is a position different from the non-detection position described earlier.

As described, the mechanism for detecting the connection state between the waste reaction liquid upstream coupling 923 and the waste reaction liquid tank coupling 623 (also referred to as a detection unit) mainly has the following constituents: the waste reaction liquid flow-channel-side detection member 821, the waste reaction liquid tray-side detection member 822, and the waste reaction liquid flow channel detection sensor 406. Thus, utilizing the mechanical action and the contact between the waste reaction liquid flow-channel-side detection member 821 and the waste reaction liquid tray-side detection member 822, the waste reaction liquid flow channel detection sensor 406 detects that the waste reaction liquid tray-side detection member 822 has moved to the detection position. Similarly, the mechanism for detecting the connection state between the waste color liquid upstream coupling 901 and the waste color liquid tank coupling 603 mainly has the following constituents: the waste color liquid flow-channel-side detection member 824, the waste color liquid tray-side detection member 825, and the waste color liquid flow channel detection sensor 405. Thus, utilizing the mechanical action and the contact between the waste color liquid flow-channel-side detection member 824 and the waste color liquid tray-side detection member 825, the waste color liquid flow channel detection sensor 405 detects that the waste color liquid tray-side detection member 825 has moved to the non-detection position. As described earlier, the mechanism for detecting the connection state between the second connecting member and the first connecting member is formed by the first detection member, the second detection member, and the detection sensor.

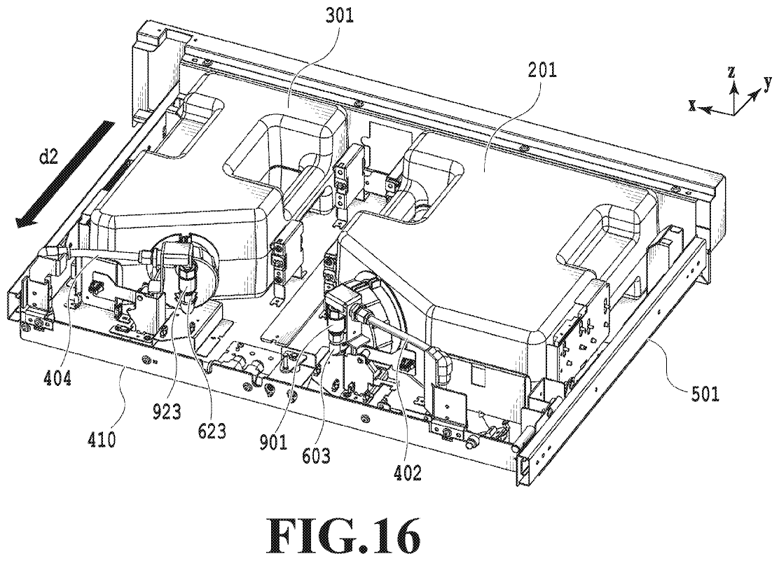

Next, the operation in which the waste liquid tank tray 410 is housed into the main body of the inkjet printing apparatus 10 is described using FIGS. 16, 17A, 17B, 18A, and 18B. FIG. 16 is a perspective view of the operation in which the waste liquid tank tray 410 is housed into the main body of the liquid ejection apparatus. The extendable tank tray rail unit 501 is provided and fixed to the waste liquid tank tray 410. A user can house the waste liquid tank tray 410 into the main body of the inkjet printing apparatus 10 by pushing the waste liquid tank tray 410 in the −y-direction from the front side of the main body of the inkjet printing apparatus 10 and moving the waste liquid tank tray 410 in the direction of arrow d2.

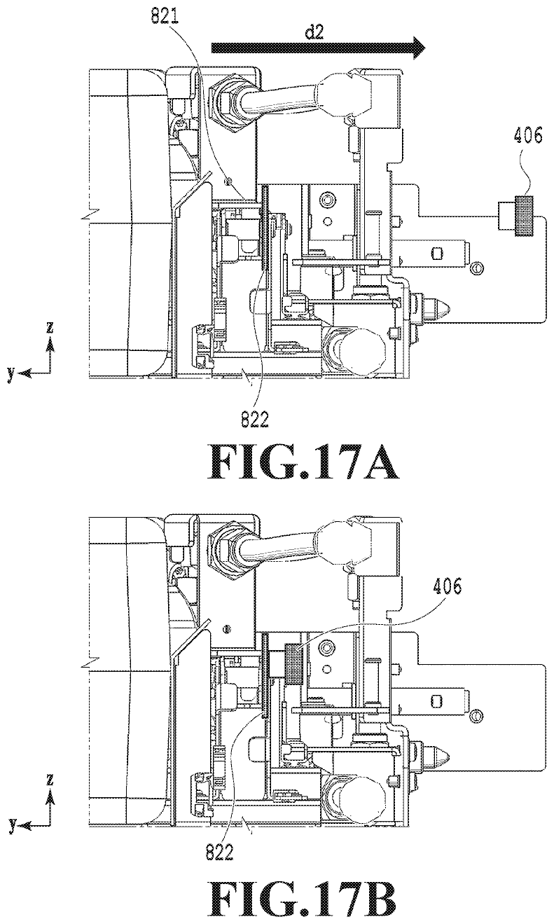

FIGS. 17A and 17B are diagrams in the xz-plane, showing the operation in which the waste liquid tank tray 410 is housed into the main body of the inkjet printing apparatus 10 with the waste reaction liquid tank coupling 623 and the waste reaction liquid upstream coupling 923 connected. FIG. 17A shows a state before the waste liquid tank tray 410 is housed into the main body of the inkjet printing apparatus 10. FIG. 17B shows a state in which the waste liquid tank tray 410 is housed in the main body of the inkjet printing apparatus 10.

As shown in FIG. 17A, before the waste liquid tank tray 410 is housed in the main body, the waste reaction liquid tray-side detection member 822 and the waste reaction liquid flow channel detection sensor 406 are away from each other in the y-direction. As the waste liquid tank tray 410 moves in the direction of arrow d2 (the −y-direction), the waste reaction liquid tray-side detection member 822 and the waste reaction liquid flow channel detection sensor 406 get closer to each other. Then, as shown in FIG. 17B, the waste reaction liquid tray-side detection member 822 and the waste reaction liquid flow channel detection sensor 406 come into contact. The waste reaction liquid flow channel detection sensor 406 is a push-type switch and can detect contact. Thus, the waste reaction liquid flow channel detection sensor 406 can detect that the waste reaction liquid tray-side detection member 822 is at a desired position, i.e., that the waste reaction liquid upstream coupling 923 and the waste reaction liquid tank coupling 623 are connected. At the same time, the waste reaction liquid flow channel detection sensor 406 can also detect that the waste liquid tank tray 410 has been housed into the main body of the inkjet printing apparatus 10. In other words, in the state in FIG. 17B, the tank is housed and fixed in the waste liquid tank tray 410, the waste liquid tank tray 410 is housed in the main body of the inkjet printing apparatus 10, and the waste reaction liquid tray-side detection member 822 is at the detection position. In this state, it is detected that the push-type switch and the waste reaction liquid tray-side detection member 822 are in contact.

The above embodiment describes an example where the waste reaction liquid flow channel detection sensor 406 is a push-type switch. However, the waste reaction liquid flow channel detection sensor 406 does not have to be a push-type switch as long as it is a detection unit capable of detecting a change in the relative distance to a target. For example, a non-contact reflective sensor may be used to detect approach of the waste reaction liquid tray-side detection member 822. Also, a non-contact light interruption/transmission detection sensor may be used for the detection based on whether light transmits through or is interrupted by part of the waste reaction liquid tray-side detection member 822.

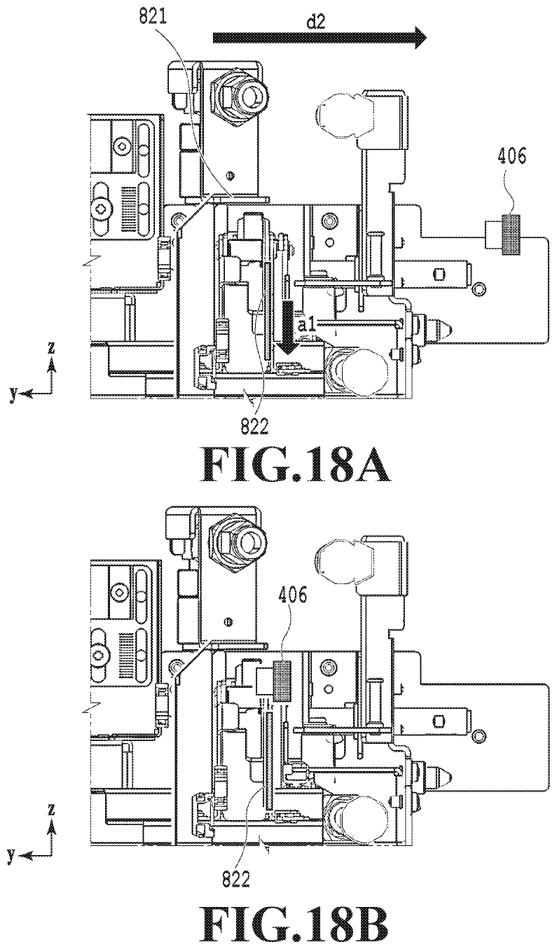

FIGS. 18A and 18B are diagrams in the xz-plane, showing the operation in which the waste liquid tank tray 410 is housed into the main body of the printing apparatus with the waste reaction liquid tank coupling 623 and the waste reaction liquid upstream coupling 923 being not connected (in the disconnected state). FIG. 18A shows a state before the waste liquid tank tray 410 is housed into the main body of the inkjet printing apparatus 10. FIG. 18B shows a state in which the waste liquid tank tray 410 is housed in the main body of the inkjet printing apparatus 10.

As shown in FIG. 18A, the waste reaction liquid tray-side detection member 822 is located at a position offset in the-z-direction from the horizontal direction (the y-axis direction) of the waste reaction liquid flow channel detection sensor 406. Thus, as shown in FIG. 18B, even after the waste liquid tank tray 410 moves in the direction of arrow d2 (the −y-direction) and is housed into the main body of the inkjet printing apparatus 10, the waste reaction liquid tray-side detection member 822 and the waste reaction liquid flow channel detection sensor 406 do not come into contact. Thus, the state of the waste reaction liquid flow channel detection sensor 406, which is a push-type switch, does not change. Thus, it can be assumed that the waste reaction liquid upstream coupling 923 and the waste reaction liquid tank coupling 623 are not connected. FIGS. 18A and 18B are diagrams where the waste reaction liquid tank 301 is not housed. However, in a case where the waste reaction liquid tank coupling 623 and the waste reaction liquid upstream coupling 923 are half-inserted, the waste reaction liquid flow-channel-side detection member 821 is not located at the desired location, and thus, the waste reaction liquid tray-side detection member 822 does not come into contact with the waste reaction liquid flow channel detection sensor 406 in this case either. In a configuration where the waste reaction liquid tray-side detection member 822 is biased in the direction of arrow a1 by spring biasing, the biasing force of the spring is desirably such that the sprint does not get pushed back by the half-inserted waste reaction liquid upstream coupling 923. In other words, the spring force is desirably such that the waste reaction liquid tank coupling 623 and the waste reaction liquid upstream coupling 923 will not be fixed in a half-inserted state.

The above-described operation in which the waste liquid tank tray 410 is housed into the main body of the inkjet printing apparatus 10 is the same for the waste color liquid side as well.

FIGS. 19A and 19B are each a top view of the waste liquid tank tray 410 illustrating piping of the waste liquid flow channel (the waste liquid tank tray 410 is looked down on in the-z-direction). FIG. 19A is a top view of the waste liquid tank tray 410 with the waste color liquid tank 201 and the waste reaction liquid tank 301 not housed therein, and FIG. 19B is a top view of the waste liquid tank tray 410 with the waste color liquid tank 201 and the waste reaction liquid tank 301 housed therein.

As shown in FIG. 19A, the waste reaction liquid flow channel 404 includes a waste reaction liquid tube piping member 1302 (also referred to as a first piping member) and a waste reaction liquid tube 1301 (also referred to as a second piping member). The waste reaction liquid tube piping member 1302 is attached and fixed to the waste liquid tank tray 410. An upstream side of the waste reaction liquid tube 1301 is connected to the waste reaction liquid tube piping member 1302. The waste reaction liquid tube piping member 1302 restricts the waste reaction liquid tube 1301 in terms of the direction in which the waste reaction liquid tube 1301 is located. The waste reaction liquid tube 1301 is made of an elastic material. The waste reaction liquid tube 1301 is, in its natural state, linear in shape. As shown in FIG. 19A, with the waste reaction liquid tank 301 not housed, the waste reaction liquid flow-channel-side detection member 821 is disposed not to overlap with the waste reaction liquid tray-side detection member 822 on an xy-plane. In other words, with the waste reaction liquid tank 301 not housed, the waste reaction liquid flow-channel-side detection member 821 and the waste reaction liquid tray-side detection member 822 are disposed so as not to overlap in a top view. This prevents a situation where the waste reaction liquid flow-channel-side detection member 821 and the waste reaction liquid tray-side detection member 822 come into contact with each other in a case where the waste reaction liquid tank 301 is not housed.

FIG. 19B is a top view of the waste liquid tank tray 410 showing a state where the waste color liquid tank 201 and the waste reaction liquid tank 301 are housed therein (the waste liquid tank tray 410 is looked down on in the-z-direction). As shown in FIG. 19B, the waste liquid tank positioning springs 1305 are attached to the waste liquid tank tray 410. The waste reaction liquid tank 301 is fixed at a desired position on the waste liquid tank tray 410 by its own weight and biasing from the waste liquid tank positioning springs 1305. Also, as shown in FIG. 19B, with the waste reaction liquid tank 301 being housed, the waste reaction liquid flow-channel-side detection member 821 is disposed at a position overlapping with the waste reaction liquid tray-side detection member 822 on the xy-plane. In other words, with the waste reaction liquid tank 301 being housed, the waste reaction liquid flow-channel-side detection member 821 and the waste reaction liquid tray-side detection member 822 are disposed to overlap in a top view. This is because the waste reaction liquid tube 1301, which is made of an elastic material, bends to a degree not to buckle and is deformed substantially in the −y-direction due to its elasticity.

The above-described change in the state of the flow channel between the state where the waste reaction liquid tank 301 is not housed and the state where the waste reaction liquid tank 301 is housed (a change in the positional relation between the waste liquid flow-channel-side detection member and the waste liquid tray-side detection member) is the same for the waste color liquid side as well.

### Control Configuration

The configuration described above can detect whether the flow channel is in the connected state or in the disconnected state. Thus, control can be performed so that liquid will not be supplied to the flow channel in the event where the detection sensor detects that the waste liquid flow channel upstream coupling, which is the second connecting member, and the waste liquid tank coupling, which is the first connecting member, are not connected.

Control for executing such control can be executed using the control configuration in FIG. 11 described in the second embodiment. The control configuration in FIG. 11 is as described in the second embodiment.

### Example Control by Liquid Ejection Apparatus

In the event where the detection sensor detects that the waste liquid flow channel upstream coupling, which is the second connecting member, and the waste liquid tank coupling, which is the first connecting member, are not connected, the control unit 254 of the inkjet printing apparatus 10 can perform control so that liquid will not be supplied to the flow channel. Specifically, upon detection that the waste liquid flow channel upstream coupling and the waste liquid tank coupling are not connected, the control unit 254 of the inkjet printing apparatus 10 performs control so that liquid will not be supplied to the flow channel. To this end, a mechanism capable of opening and closing the flow channel is provided upstream of the waste liquid tank. For example, a tube pump can be used as the mechanism capable of opening and closing the flow channel. For the waste color liquid tank 201, the pump 202 provided upstream thereof can be controlled as a tube pump. Further, the pump 204 and the pump 210 may also be controlled as tube pumps. For the waste reaction liquid tank 301, the pump 302 upstream thereof can be controlled as a tube pump. Further, the pump 304 and the pump 310 may also be controlled as tube pumps. A tube pump other than the pumps mentioned above may be provided upstream of the waste color liquid tank 201 or the waste reaction liquid tank 301 and used for the control.

Also, in the state where the waste liquid flow channel upstream coupling, which is the second connecting member, and the waste liquid tank coupling, which is the first connecting member, are not connected, i.e., the first connecting member is at the non-detection position, the control unit 254 performs control so that the tube pump will not be activated. In the state where the waste liquid flow channel upstream coupling, which is the second connecting member, and the waste liquid tank coupling, which is the first connecting member, are connected, i.e., the first connecting member is at the detection position, the control unit 254 performs control so that the tube pump can be activated.

According to the above described present embodiment, even in a case where a user conducting the work of removing or inserting the coupling of the flow channel makes a mistake such as forgetting to connect the coupling or inserting the coupling incompletely, it can be detected using the detection unit. Thus, upon detection of a disconnected or half-inserted state of the coupling, control is performed so that liquid (waste liquid) will not flow into the flow channel, which makes it possible to prevent the liquid from leaking out of the flow channel. Thus, the configuration of the present embodiment makes it possible to provide a liquid ejection apparatus having a fail-safe mechanism.

Further, according to the present embodiment, the same detection unit as the one described above can be used to detect whether the waste liquid tank is not housed in the waste liquid tank tray. Thus, a single detection unit can be used to detect two states: whether the couplings are connected and whether the waste liquid tank is housed. Thus, applying the present embodiment makes it possible to achieve a fail-safe mechanism at low cost compared to a case where separate detection units are provided for detection of whether the couplings are connected and detection of whether the waste liquid tank is housed.

The present embodiment can therefore provide a liquid ejection apparatus having a fail-safe mechanism for the work of removing or inserting the flow channel from or to the waste liquid tank.

### Other Embodiments

The first embodiment describes an example of a liquid ejection apparatus where the atmosphere communication port is switched between the closed state and the open state in conjunction with switching of the connecting unit between the disconnected state and the connected state. However, the configuration of the first embodiment can also be applied similarly to the flow channel on the supply side.

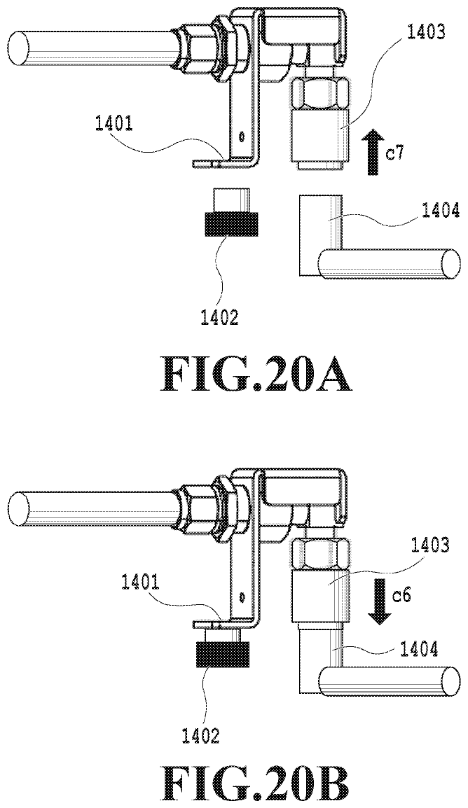

Also, the third embodiment demonstrates an example where the detection unit is formed by three constituents: the flow-channel-side detection member, which is the second detection member, the waste-liquid-tank-side detection member, which is the first detection member, and the detection sensor provided at the main body of the inkjet printing apparatus 10. Thus, a single detection sensor can be used to detect not only whether the couplings are connected, but also whether the waste liquid tank is housed. As an alternative configuration, a detection sensor may be provided directly at a first one of the waste liquid tank tray 410 and the upstream coupling, and a detection member may be provided at a second one of them. In this case, once the couplings are connected, the detection member provided at the second one of them comes into contact with the detection sensor provided at the first one of them, and based on this contact, it can be detected that the couplings are in the connected state. For example, FIGS. 20A and 20B are schematic diagrams of a mechanism for detecting that the flow channel is in the connected state. A downstream coupling 1404 and a waste liquid flow channel detection sensor 1402 are fixed. Then, a flow-channel-side detection member 1401 is provided at an upstream coupling 1403. As shown in FIG. 20A, once the upstream coupling 1403 is moved in the direction of c7 and pulled off from the downstream coupling 1404, the waste liquid flow channel detection sensor 1402 and the flow-channel-side detection member 1401 separate from each other. As shown in FIG. 20B, once the upstream coupling 1403 is moved in the direction of c6 and connected to the downstream coupling 1404, the waste liquid flow channel detection sensor 1402 and the flow-channel-side detection member 1401 come into contact, by which the connection can be detected.

Also, although the third embodiment describes a mechanism for detecting connection between the second connecting member provided at the first liquid flow channel and the first connecting member provided at the waste liquid tank, it is also possible to apply the mechanism to detect connection between connecting members provided at the first liquid flow channel. For example, the mechanism can be applied also for detecting connection between couplings provided at an ink tube as long as one of the ink tube couplings is fixed.

Further, although FIGS. 19A and 19B for the above embodiment illustrate a configuration for detecting whether the waste liquid tank is housed, it does not have to be the waste liquid tank that is housed. For example, in a case where, e.g., tubes are arranged closely, a waste liquid tube may bend due its elasticity upon housing of any tangible object, causing the flow-channel-side detection member, which is the second detection member, and the waste liquid tank-side detection member, which is the first detection member, to move and overlap in a top view.

Also, while a fail-safe mechanism for connection of the waste liquid tank to the flow channel is described in the above embodiment, the present disclosure can be applied similarly to the flow channel on the supply side.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The present disclosure can provide a liquid ejection apparatus having a tank for storing liquid improved in reliability by mitigating deterioration caused by tank attachment/detachment work.

This application claims the benefit of Japanese Patent Application No. 2025-054629, filed Mar. 27, 2025, and Japanese Patent Application No. 2025-055931, filed Mar. 28, 2025, both of which are hereby incorporated by reference herein in their entirety.

What is claimed is:

1. A liquid ejection apparatus comprising:
a first tank configured to store liquid;
a first liquid flow channel configured for discharge of the liquid into the first tank; and
a connecting unit configured to disconnect the first tank from the first liquid flow channel in a disconnected state and connect the first tank to the first liquid flow channel in a connected state, wherein:
the first tank includes a waste liquid port for discarding the liquid stored in the first tank and a cap for closing the waste liquid port,
the cap includes a liquid discharging port for receiving liquid from the first liquid flow channel and an atmosphere communication port for exhausting the first tank to atmosphere,
a downstream side of the connecting unit is connected to the liquid discharging port and an upstream side of the connecting unit is connected to the first liquid flow channel, to establish flow between the first liquid flow channel and the first tank,
the atmosphere communication port includes an opening/closing unit configured to switch the atmosphere communication port between an open state and a closed state, and
the opening/closing unit is configured to switch the atmosphere communication port between the open state and the closed state in conjunction with the connecting unit switching between the disconnected state and the connected state.

2. The liquid ejection apparatus according to claim 1, wherein
the cap is provided at a side surface of the first tank in a state where the first tank is housed in a main body of the liquid ejection apparatus.

3. The liquid ejection apparatus according to claim 1, wherein
the connecting unit includes
a first connecting member having a downstream side attached and fixed to the liquid discharging port, and
a second connecting member having a downstream side for connecting to and disconnecting from an upstream side of the first connecting member and an upstream side connected to the first liquid flow channel.

4. The liquid ejection apparatus according to claim 3, wherein
the connecting unit is in the disconnected state in a case where the first connecting member and the second connecting member are disconnected, and
the connecting unit is in the connected state in a case where the first connecting member and the second connecting member are connected.

5. The liquid ejection apparatus according to claim 3, wherein
the opening/closing unit is configured to close the atmosphere communication port in a case where the first connecting member and the second connecting member are disconnected, and
the opening/closing unit is configured to open the atmosphere communication port in a case where the first connecting member and the second connecting member are connected.

6. The liquid ejection apparatus according to claim 5, wherein
the opening/closing unit includes a movable member inserted through the atmosphere communication port, movable between a closing position where the opening/closing unit closes the atmosphere communication port and an opening position where the opening/closing unit opens the atmosphere communication port,
the movable member moves to the closing position and closes the atmosphere communication port in a case where the first connecting member and the second connecting member are disconnected, and
the movable member moves to the opening position and opens the atmosphere communication port in a case where the first connecting member and the second connecting member are connected.

7. The liquid ejection apparatus according to claim 6, wherein
the opening/closing unit further includes
an elastic member configured to move the movable member to the closing position due to a biasing force and fix the movable member at the closing position in a state where the first connecting member and the second connecting member are disconnected, and
a closure member fixed to an end portion of the movable member inside the first tank to close an inside of the first tank in a case where the movable member is moved to the closing position.

8. The liquid ejection apparatus according to claim 7, wherein
in a case where the first connecting member and the second connecting member are disconnected, the opening/closing unit closes the atmosphere communication port by:
the movable member moving to the closing position due to the biasing force of the elastic member, bringing the closure member into close contact with a peripheral portion of the atmosphere communication port on the inside of the first tank, and
in a case where the first connecting member and the second connecting member are connected, the opening/closing unit opens the atmosphere communication port by:
the second connecting member pushing the movable member toward the first tank, moving the movable member to the opening position.

9. The liquid ejection apparatus according to claim 7, wherein
the elastic member is a spring, and
the closure member is a seal member.

10. The liquid ejection apparatus according to claim 3, wherein
the first tank has includes a first positioning portion,
the cap has a second positioning portion provided in correspondence to the first positioning portion, and
in closing the waste liquid port by attaching the cap to the first tank, an attachment position of the cap is determined by a positional relation between the first positioning portion and the second positioning portion.

11. The liquid ejection apparatus according to claim 10, wherein
in closing the waste liquid port by attaching the cap to the first tank, the second positioning portion of the cap abuts against the first positioning portion of the first tank in a rotational direction of the cap, and
a rotation stop position of the cap is determined by abutting against the first positioning portion of the first tank in a rotational direction.

12. The liquid ejection apparatus according to claim 11, wherein
in a case where the first tank is housed in a main body of the liquid ejection apparatus with the cap attached to the first tank and closing the waste liquid port, the atmosphere communication port is located above the liquid discharging port.

13. The liquid ejection apparatus according to claim 3, further comprising a second tank provided upstream of the first tank, wherein
a downstream end portion of the first liquid flow channel is a liquid outflow port and connected to the second connecting member, and
an upstream end portion of the first liquid flow channel is a liquid inflow port formed in the second tank.

14. The liquid ejection apparatus according to claim 13, further comprising:
a second liquid flow channel configured for the liquid to flow into the second a liquid detection unit provided at the second tank and configured to detect a liquid level in the second tank;
a first pump provided on the first liquid flow channel, between the second connecting member and the second tank; and
a second pump provided on the second liquid flow channel, upstream of the second tank.

15. The liquid ejection apparatus according to claim 14, further comprising a control unit, wherein
in a case where a liquid level in the first tank is higher than the liquid discharging port of the first tank, the control unit performs control so that the liquid level in the second tank is located above the liquid inflow port of the first liquid flow channel.

16. The liquid ejection apparatus according to claim 1, wherein
the liquid is waste liquid collected from a liquid ejection head.

17. A liquid ejection apparatus comprising:
a tank configured to store liquid;
a liquid flow channel configured to connect to the tank to allow the liquid to flow into the tank and to disconnect from the tank;
a first connecting member provided at the tank,
a second connecting member provided at a downstream end portion of the liquid flow channel;
the first connecting member configured to connect to the second connecting member for the liquid from the liquid flow channel to flow into the tank; and
a detection unit configured to detect a connected state of the first connecting member and the second connecting member by detecting a detection member configured to change in position upon connection of the first connecting member and the second connecting member.

18. The liquid ejection apparatus according to claim 17, further comprising:
a support unit configured to house the tank; and
an other detection member provided at the second connecting member, wherein the detection member is provided at the support unit, and
the detection unit includes a detection sensor configured to detect that the detection member is at a detection position.

19. The liquid ejection apparatus according to claim 18, wherein
in a case where the first connecting member and the second connecting member are in a disconnected state, the first connecting member moves to a non-detection position different from the detection position, and
in a case where the first connecting member and the second connecting member are in the connected state, the other detection member acts on the detection member, moving the detection member to the detection position.

20. The liquid ejection apparatus according to claim 19, wherein
the detection member is rotatable around a shaft fixed to the support unit,
in a case where the first connecting member and the second connecting member are in the disconnected state, the detection member rotates and moves to the non-detection position for the detection sensor, and
in a case where the first connecting member and the second connecting member are in the connected state, the other detection member acts on the detection member, rotating and moving the detection member to the detection position.

21. The liquid ejection apparatus according to claim 18, wherein
the detection sensor is a push-type switch, and
in a case where the detection member is at the detection position with the tank housed in and fixed to the support unit and the support unit is housed in a main body of the liquid ejection apparatus, contact between the push-type switch and the detection member is detected.

22. The liquid ejection apparatus according to claim 19, wherein
in a case where the first connecting member and the second connecting member are in the connected state with the tank housed in and fixed to the support unit and the support unit housed in a main body of the liquid ejection apparatus, the second connecting member is in a fixed position.

23. The liquid ejection apparatus according to claim 19, wherein
the support unit is separable from a main body of the liquid ejection apparatus, and
the tank is removable from the support unit by disconnecting the first connecting member and the second connecting member from each other with the support unit separated from the main body of the liquid ejection apparatus.

24. The liquid ejection apparatus according to claim 23, wherein
in a case where the tank is removed from the support unit, the detection member is biased toward the non-detection position.

25. The liquid ejection apparatus according to claim 18, wherein the detection sensor is attached to a main body of the liquid ejection apparatus.

26. The liquid ejection apparatus according to claim 24, wherein
in a state where the support unit is separated from the main body of the liquid ejection apparatus, the detection sensor does not detect the detection member, in a case where the first connecting member and the second connecting member are in the connected state and
in a state where the support unit is housed in the main body of the liquid ejection apparatus, the detection sensor detects that the detection member is at the detection position, in a case where the first connecting member and the second connecting member are in the connected state.

27. The liquid ejection apparatus according to claim 19, wherein
the liquid flow channel includes a first piping member whose upstream side is fixed to the support unit and a second piping member whose upstream side is connected to a downstream side of the first piping member,
the second piping member is made of an elastic material,
in a case where the tank is not housed in the support unit, the detection member and the other detection member do not to overlap in a top view, and
in a case where the tank is housed in the support unit, the detection member and the other detection member are moved by elasticity of the second piping member to positions overlapping in the top view.

28. The liquid ejection apparatus according to claim 19, further comprising a mechanism upstream of the liquid flow channel, the mechanism configured to open and close a flow channel.

29. The liquid ejection apparatus according to claim 28, wherein the mechanism is a tube pump.

30. The liquid ejection apparatus according to claim 29, further comprising a control unit, wherein
the control unit performs control so that
the tube pump is not activated in a case where the detection member is at the non-detection position, and
the tube pump is enabled to be activated in a case where the detection sensor detects that the detection member is at the detection position.

31. The liquid ejection apparatus according to claim 17, wherein
the liquid is waste liquid collected from a liquid ejection head.
